(19) United States
(12) Patent Application Publication
(10) Pub. No.: US 2024/0080462 A1
(43) Pub. Date: Mar. 7, 2024

(54) Systems and Methods for Low-Resolution Motion Estimation Searches

(71) Applicant: Apple Inc., Cupertino, CA (US)

(72) Inventors: Jae Young Park, Los Gatos, CA (US); Athanasios Leontaris, Cupertino, CA (US)

(21) Appl. No.: 18/084,989

(22) Filed: Dec. 20, 2022

Related U.S. Application Data
(60) Provisional application No. 63/404,106, filed on Sep. 6, 2022.

(51) Int. Cl. H04N 19/186; H04N 19/176; H04N 19/513

(52) U.S. Cl. CPC H04N 19/186; H04N 19/176; H04N 19/513

(57) ABSTRACT

A video encoding system may include a low resolution pipeline configured to receive source image data corresponding with a luma coding block and a chroma coding block of a coding unit in an image. The low resolution pipeline includes a low resolution motion estimation block configured to generate a downscaled luma block and a downscaled chroma prediction block respectively corresponding to a luma prediction block in the luma coding block and a chroma prediction block in the chroma coding block. The low resolution motion estimation block also performs motion estimation searches based on the luma prediction block and the chroma prediction block to determine downscaled reference samples and motion vector candidates. The video encoding system also includes a main encoding pipeline configured to receive the source image data and to determine encoding parameters to be used to encode coding blocks based on the determined motion vector candidates.

### CROSS-REFERENCE TO RELATED APPLICATIONS

This application claims priority to U.S. Application No. 63/404,106, entitled “Systems and Methods for Low Resolution Motion Estimation Searches,” filed Sep. 6, 2022, which is hereby incorporated by reference in its entirety for all purposes.

### BACKGROUND

The present disclosure generally relates to image processing, and, more particularly, to video encoding.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic devices often use one or more electronic displays to present visual representations of information, for example, as text, still images, and/or video based on corresponding image data. Since image data may be received from another electronic device and/or stored in the electronic device, the image data may be encoded (e.g., compressed) to reduce size (e.g., number of bits) and, thus, resources (e.g., transmission bandwidth and/or memory addresses) used to transmit and/or store image data. To display image frames, the electronic device may decode encoded image data and instruct the electronic display to adjust luminance of its display pixels based on the decoded image data.

To facilitate encoding, prediction techniques may be used to indicate the image data by referencing other image data. For example, since successively displayed images (e.g., image frames) may be generally similar, inter (e.g., inter-frame) prediction techniques may be used to indicate image data (e.g., a prediction unit) corresponding with a first image frame by referencing image data (e.g., a reference sample) corresponding with a second image frame, which may be displayed before or after the first image frame. To facilitate identifying the reference sample, a motion vector may indicate position of a reference sample in the second image frame relative to position of a prediction unit in the first image frame. In other words, instead of directly compressing the image data, the image data may be encoded based at least in part on a motion vector used to indicate desired value of the image data.

In some instances, motion vectors may be accurate or less indicative of a trend (e.g., motion) in image data. For example, when prediction techniques are utilized using only the luma component of image data, motion vectors may be inaccurate, which may thereby cause image data to be encoded in a potentially undesirable manner. As such, to enable enhanced encoding of image data, improved techniques for identifying motion vectors and encoding image data may be desirable.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to processing techniques that may be utilized when performing image processing. For example, the techniques described herein may be utilized as part of a process for encoding source image data. In particular, the techniques described herein relate to scaling source image data prior to performing encoding operations such as determining encoding parameters. For instance, full-resolution image data and low-resolution image data may be derived from source image data. The full-resolution image data may be encoded based on encoding parameters that can be determined based on the low-resolution image data and the full-resolution image data. By utilizing scaled image data, memory bandwidth may be reduced. Additionally, as discussed below, portions of a video encoding system may utilize the low-resolution image data to perform low-resolution motion estimation techniques without downscaling image data (e.g., full-resolution image data). As also discussed below, multiple searches may be performed using downscaled (e.g., low-resolution image data), which may improve the accuracy of the techniques utilized to encode the source image data. Accordingly, the techniques described herein may enable video encoding systems to encode image data more efficiently.

A video encoding system may determine encoding parameters and implement the encoding parameters to encode the full-resolution image data that is generated from source image data. In some embodiments, the full-resolution image data may be encoded using prediction techniques (e.g., inter prediction techniques) by referencing other image data. For example, inter prediction techniques may facilitate encoding the full-resolution image data by referencing image data used to display other image frames.

The video encoding system may determine a reference sample in a second (e.g., reference) image frame for full-resolution image data corresponding with a first image frame using an inter prediction mode. The inter prediction mode may include a motion vector that indicates position (e.g., spatial position) of the reference sample in the second image frame relative to position of the source image data in the first image frame. Additionally, the inter prediction mode may include a reference index that indicates display order (e.g., temporal position) of the second image frame relative to the first image frame.

A motion estimation (ME) block in the video encoding system may determine one or more candidate inter prediction modes. The motion estimation block may perform a motion estimation search to determine reference samples that are similar to the full-resolution image data. Once a reference sample is determined, the motion estimation block may determine a motion vector and reference index to indicate location (e.g., spatial position and temporal position) of the reference sample relative to the full-resolution image data. Generally, performing motion estimation searches may be computationally complex and, thus, time-consuming. However, a duration provided for the motion estimation block to perform its search may be limited, particularly to enable real-time or near real-time transmission or display as refresh rate and/or resolution increases.

Accordingly, the present disclosure provides techniques to improve operational efficiency of the video encoding system. In some embodiments, operational efficiency may be improved by including a low resolution pipeline in parallel with a main encoding pipeline, which determines encoding parameters used to encode the full-resolution image data. Additionally, in some embodiments, the low resolution pipeline and the main encoding pipeline may both be provided access via direct memory access (DMA) to the full-resolution image data and low-resolution image data (derived from the source image data and) stored in memory.

Thus, in such embodiments, the low resolution pipeline and the main encoding pipeline may operate using relatively independent operational timing, which may enable the low resolution pipeline to operate one or more image frames ahead of the main encoding pipeline. In this manner, the low resolution pipeline may determine information ahead of time for use in the main encoding pipeline. By running the low resolution pipeline at least one image frame ahead of the main encoding pipeline, information (e.g., statistics and/or low resolution inter prediction modes) determined by the low resolution pipeline may be used by the main encoding pipeline, for example, to determine motion-weight (e.g., lambda) tuning information used in rate-distortion calculations, frame-rate conversion, image stabilization, and/or the like.

For example, the low resolution pipeline may include a low resolution motion estimation (LRME) block that processes the low-resolution image data to determine low resolution inter prediction modes. The low resolution motion estimation block may perform a motion estimation search on the low-resolution image data, which may be derived from full-resolution samples of image data used as references in the motion estimation search, to determine a downscaled reference sample that is similar to the downscaled source image data. To indicate location of the downscaled reference sample, the low resolution motion estimation block may determine a low resolution inter prediction mode, which includes a motion vector and a reference index.

Since downscaled image data (the low-resolution image data) should be similar to the full-resolution image data, low resolution inter prediction modes may provide an indication where reference samples in full resolution are expected to be located. Accordingly, the motion estimation block in the main encoding pipeline may be initialized with the low resolution inter prediction modes as candidates. In this manner, the low resolution motion estimation block may facilitate reducing amount of image data searched by the motion estimation block and, thus, improving operational efficiency of the video encoding system. To improve processing efficiency, the low resolution motion estimation block may prune the low resolution inter prediction modes before they are evaluated as candidate inter prediction modes by the main encoding pipeline, for example, to consolidate similar low resolution inter prediction modes and, thus, to enable the number of candidate inter prediction modes evaluated by the main encoding pipeline to be reduced.

Additionally, when the low resolution motion estimation block is operating one or more image frame ahead of the main encoding pipeline, the low resolution motion estimation block may determine statistics based at least in part on luma of the source image data. In some embodiments, the statistics may be indicative of global motion across multiple image frames and, thus, used for image stabilization. For example, the low resolution motion estimation block may determine a histogram statistic used to determine a best motion vector and, thus, a global motion vector determined based at least in part on the best motion vector. Based on the global motion statistics, the motion estimation block, which may be implemented in the main encoding pipeline, may determine a global motion vector indicative of motion across multiple image frames. Additionally, based on the global motion vector, the motion estimation block may adjust the candidate inter prediction modes considered, for example, by adjusting (e.g., offsetting) their motion vectors based at least in part on the global motion vector. Furthermore a search area in image data may be adjusted based on the global motion vector.

### BRIEF DESCRIPTION OF THE DRAWINGS

Various aspects of this disclosure may be better understood upon reading the following detailed description and upon reference to the drawings in which:

FIG. 1 is a block diagram of an electronic device, in accordance with an embodiment;

FIG. 2 is an example of the electronic device of FIG. 1, in accordance with an embodiment;

FIG. 3 is another example of the electronic device of FIG. 1, in accordance with an embodiment;

FIG. 4 is another example of the electronic device of FIG. 1, in accordance with an embodiment;

FIG. 5 is another example of the electronic device of FIG. 1, in accordance with an embodiment;

FIG. 6 is another example of the electronic device of FIG. 1, in accordance with an embodiment;

FIG. 7 is block diagram of a portion of the electronic device of FIG. 1 including a video encoding system, in accordance with an embodiment;

FIG. 8 is a block diagram of the motion compensated temporal filtering circuitry of the video encoding system of FIG. 7, in accordance with an embodiment;

FIG. 9 is a diagrammatic representation of motion vector refinement completed via the motion compensated temporal filtering circuitry of FIG. 8, in accordance with an embodiment;

FIG. 10 is a diagrammatic representation of motion vector refinement using motion vector neighbor values in accordance with an embodiment;

FIG. 11 is a diagrammatic representation of luma pixel value and chroma pixel value calculations for temporal filtering of pixel values, in accordance with an embodiment;

FIG. 12 is a flow diagram of a process of motion compensated temporal filtering, in accordance with an embodiment;

FIG. 13 is a flow diagram of a process for refining motion vectors, in accordance with an embodiment;

FIG. 14 is a flow diagram of process for temporal filtering, in accordance with an embodiment;

FIG. 15 is a block diagram of a portion of the video encoding system of FIG. 7 including a low resolution motion estimation block and a motion estimation block along with the image sensor and image pre-processing circuitry of FIG. 1, in accordance with an embodiment;

FIG. 16 is a flow diagram for performing low resolution motion estimation searches in a first and second mode of operation using the video encoding system of FIG. 7, in accordance with an embodiment;

FIG. 17 is a flow diagram of a process for determining a candidate low resolution inter prediction mode, in accordance with an embodiment;

FIG. 18 is a diagrammatic representation of an image divided into coding blocks and prediction blocks, in accordance with an embodiment; and

FIG. 19 is a diagrammatic representation of available and unavailable blocks when utilizing spatial candidates, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

An electronic device may facilitate visually presenting information by instructing an electronic display to display one or more images (e.g., image frames) based on corresponding image data. In some embodiments, the image data may be generated by an image sensor (e.g., digital camera) and stored in the electronic device. Additionally, when the image data is generated external from the electronic display, the image data may be transmitted to the electronic device. To reduce resource usage, image data may be encoded (e.g., compressed) to reduce size (e.g., number of bits) which, for example, may reduce transmission bandwidth and/or memory address usage.

A video encoding system may determine encoding parameters and implement the encoding parameters to encode source image data. To facilitate encoding, source image data for an image may be divided into one or more coding units. As used herein, a “coding unit” is intended to describe a sample of source image data (e.g., pixel image data) corresponding to a group of display pixels, which is encoded using the same prediction technique. However, it should be noted that “coding unit” may also refer to a sample of image data that is generated from source image data. For instance, as described herein, source image data may be scaled to generate different sets of image data (e.g., scaled image data). The sets of scaled image data, as discussed below, may include full-resolution image data and low-resolution image data. In such a case, a “coding unit” may be a sample of the full-resolution image data generated from source image data.

Accordingly, the video encoding system may determine a prediction technique (e.g., intra prediction technique or inter prediction technique) to be implemented to predict a coding unit, for example, as one or more prediction samples. Prediction techniques may facilitate encoding by enabling the source image data to be indicated via reference to other image data. For example, since an image frame may change gradually, the video encoding system may utilize intra prediction techniques to produce a prediction sample based on image data used to display the same image. Additionally, since successively displayed images may change gradually, the video encoding system may utilize inter prediction techniques to produce a prediction sample based on image data used to display other images.

Although conceptually similar, each prediction technique may include one or more prediction modes that utilize different encoding schemes. In other words, implementing different prediction modes may result in different prediction samples. For example, utilizing a first intra prediction mode (e.g., vertical prediction mode), the video encoding system may produce a prediction sample with each column set equal to image data for a pixel directly above the column. On the other hand, utilizing a second intra prediction mode (e.g., DC prediction mode), the video encoding system may produce a prediction sample set equal to an average of adjacent pixel image data. Additionally, utilizing a first inter prediction mode (e.g., first reference index and first motion vector), the video encoding system may produce a prediction sample based on a reference sample at a first position within a first image frame. Utilizing a second inter prediction mode (e.g., second reference index and second motion vector), however, the video encoding system may produce a prediction sample based on a reference sample at a second position within a second image frame.

Although using the same prediction technique, a coding unit may be predicted using one or more different prediction modes. As using herein, a “prediction unit” is intended to describe a sample within a coding unit that utilizes the same prediction mode. In some embodiments, a coding unit may include a single prediction unit. In other embodiments, the coding unit may be divided into multiple prediction units, which each uses a different prediction mode.

Accordingly, the video encoding system may evaluate candidate prediction modes (e.g., candidate inter prediction modes, candidate intra prediction modes, and/or a skip mode) to determine what prediction mode to use for each prediction unit in a coding unit. To facilitate, a motion estimation (ME) block in the video encoding system may determine one or more candidate inter prediction modes. In some embodiments, an inter prediction mode may include a reference index (e.g., temporal position), which indicates in which image a reference sample is located, and a motion vector (e.g., spatial position), which indicates the position of the reference sample relative to a prediction unit.

To determine a candidate inter prediction mode, the motion estimation block may search image data (e.g., reconstructed samples) used to display other image frames for reference samples that are similar to a prediction unit. Once a reference sample is determined, the motion estimation block may determine a motion vector and reference index to indicate location of the reference sample.

Generally, the quality of the match between prediction unit and reference sample may be dependent on search area (e.g., amount of image data). For example, increasing search area may improve likelihood of finding a closer match with the prediction unit. However, increasing search area may also increase computation complexity as well as increase memory bandwidth utilized to perform searches, which may cause increases in searching duration. In some embodiments, duration provided for the motion estimation block to perform its search may be limited, for example, to enable real-time or near real-time transmission and/or display.

Accordingly, as will be described in more detail below, the present disclosure provides techniques to improve operational efficiency of a video encoding system, for example, by enabling search area and/or candidate prediction modes evaluated by a main encoding pipeline to be adaptively (e.g., dynamically) adjusted based at least in part on processing performed by a low resolution pipeline. In some embodiments, operational efficiency may be improved by including a low resolution pipeline in parallel with the main encoding pipeline. Additionally, in some embodiments, the low resolution pipeline and the main encoding pipeline may both be provided access via direct memory access (DMA) to source image data stored in memory.

Thus, the low resolution pipeline and the main encoding pipeline may operate using relatively independent operational timing. In fact, the low resolution pipeline may operate one or more image frames ahead of the main encoding pipeline. In this manner, the low resolution pipeline may process image data ahead of time to determine information (e.g., low resolution inter prediction modes, luma histogram statistics, and/or sum of absolute difference statistics) to be used in the main encoding pipeline.

To facilitate determining the relevant information, the low resolution pipeline may include a low resolution motion estimation (LRME) block. In some embodiments, the low resolution motion estimation block may downscale source image data (e.g., a coding unit). For example, a low resolution motion estimation block may downscale a 32×32 coding unit to one-sixteenth resolution to generate an 8×8 downscaled coding unit. As also discussed herein, the low resolution motion estimation block may receive (e.g., via DMA access) scaled image data (e.g., downscaled image data) that is generated from source image data by other circuitry (e.g., image pre-processing circuitry) and stored in memory. In some cases, the resolution of the scaled image data may correspond to one-sixteenth of a resolution of other image data generated from source image data. For example, as discussed below, the image pre-processing circuitry may generate full-resolution image data and low-resolution image data from source image data. The low-resolution image data may have a resolution that is one-sixteenth of a resolution of the full-resolution image data. Accordingly, the low resolution motion estimation block may generate a downscaled coding unit without downscaling source image data. Rather, the low resolution motion estimation block may generate the downscaled coding unit using low-resolution image data generated by image pre-processing circuitry (e.g., by utilizing a portion of the downscaled source image data). By doing so, more resources (e.g., processing resources) of the low resolution motion estimation block may be utilized to perform motion estimation techniques. Furthermore, by generating full-resolution image data and low-resolution image data from source image data prior to performing motion estimation techniques and reading the low resolution image data (e.g., instead of the full-resolution image data) when performing low-resolution motion estimation techniques, the amount of memory bandwidth utilized to read image data may be reduced.

The low resolution motion estimation block may then search previously downscaled source image data to find (e.g., identify) a downscaled reference sample that is similar to a downscaled prediction unit within the downscaled coding unit. To indicate location of the downscaled reference sample, the low resolution motion estimation block may determine a low resolution inter prediction mode, which includes a motion vector and a reference index. More specifically, the motion vector may indicate spatial position of a reference sample in full resolution corresponding with the downscaled reference sample relative to a prediction unit in full resolution corresponding with the downscaled prediction unit. Additionally, the reference index may indicate display order (e.g., temporal position) of a reference image frame corresponding with the downscaled reference sample relative to an image frame corresponding with the downscaled prediction unit.

The low resolution motion estimation block may then enable the low resolution inter prediction mode to be accessed and used by the main encoding pipeline. In some embodiments, the low resolution motion estimation block may store the low resolution inter prediction mode in memory using direct memory access and the main encoding pipeline may retrieve the low resolution inter prediction mode using direct memory access. Additionally, the low resolution motion estimation block may store the downscaled source image data in memory for use in subsequent low resolution motion estimation searches.

In some embodiments, the motion estimation block in the main encoding pipeline may retrieve candidate inter prediction modes from memory. For each candidate inter prediction mode, the motion estimation block may perform a motion estimation search within a range of pixels (e.g., +/−3 pixel area) and/or sub-pixels (e.g., +/−0.5 pixel area) around its indicated reference sample in full resolution. Since downscaled image data should be similar to full resolution image data, low resolution inter prediction modes may provide an indication where closely matching reference samples are expected to be located. As such, the motion estimation block may utilize the low resolution inter prediction modes as candidates. In some embodiments, multiple passes of motion estimation searches (e.g., in the form of a recursive search) may be performed. In this manner, the low resolution motion estimation block may facilitate reducing amount of image data searched by the motion estimation block and, thus, searching duration, which may facilitate real-time or near real-time transmission and/or display of image data.

Additionally, when operating one or more image frames ahead of the main encoding pipeline, the low resolution motion estimation block may determine statistics used to improve operational efficiency of the main encoding pipeline. For example, the low resolution motion estimation block may determine luma histogram statistics that indicate number of pixels in downscaled image data at each luma value. Additionally or alternatively, the low resolution motion estimation block may determine a zero vector sum of absolute difference (SAD) statistics, which may indicate difference between a downscaled prediction unit and a downscaled reference sample indicated by a zero vector. In some embodiments, the statistics may be used to detect when a scene change is expected to occur.

As described above, inter prediction techniques are premised on successively displayed image frames being similar. Thus, effectiveness of inter prediction techniques across a scene change may be greatly reduced. As such, the main encoding pipeline may select a prediction mode from one or more candidate intra prediction modes and/or a skip mode. Thus, in some embodiments, the motion estimation block may be disabled, which may facilitate further reducing computational complexity, improving operational efficiency, and/or reducing power consumption of the main encoding pipeline and, thus, an electrical device in which it is implemented.

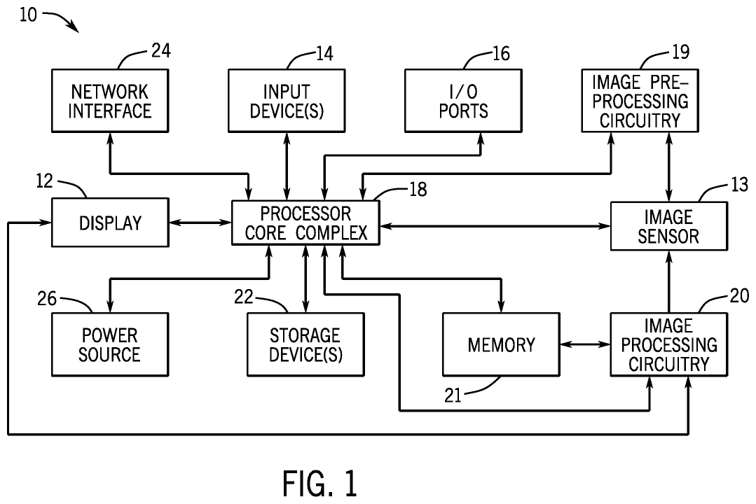

To help illustrate, an electronic device 10 (e.g., computing device) that may utilize an electronic display 12 to display image frames based on image data and/or an image sensor 13 to capture image data is described in FIG. 1. As will be described in more detail below, the electronic device 10 may be any suitable computing device, such as a handheld computing device, a tablet computing device, a notebook computer, and/or the like. Thus, it should be noted that FIG. 1 is merely one example of a particular implementation and is intended to illustrate the types of components that may be present in the electronic device 10.

The electronic device 10 includes the electronic display 12, an image sensor 13, one or more input structures 14 (e.g., input devices), one or more input/output (I/O) ports 16, a processor core complex 18 having one or more processor(s) or processor cores, image pre-processing circuitry 19, image processing circuitry 20, local memory 21, a main memory storage device 22, a network interface 24, and a power source 26. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the local memory 21 and the main memory storage device 22 may be included in a single component.

The processor core complex 18, image pre-processing circuitry 19, and image processing circuitry 20 may execute instructions stored in local memory 21 and/or the main memory storage device 22 to perform certain image processing operations. For example, the processor core complex 18 and/or image processing circuitry 20 may encode image data captured by the image sensor 13 and/or decode image data for display on the electronic display 12. Additionally, the image pre-processing circuitry 19 and image processing circuitry 20 may scale source image data (e.g., image data captured by the image sensor 13) to generate scaled image data that may be used to perform encoding operations. As such, the processor core complex 18, image pre-processing circuitry 19, and image processing circuitry 20 may include one or more general purpose microprocessors, one or more application specific processors (ASICs), one or more field programmable logic arrays (FPGAs), or any combination thereof. Additionally, in some embodiments, the image pre-processing circuitry 19, image processing circuitry 20, or both the image pre-processing circuitry 19 and the image processing circuitry 20 may be included in the processor core complex 18.

The local memory 21 and/or the main memory storage device 22 may be tangible, non-transitory, computer-readable mediums that store instructions executable by and data to be processed by the processor core complex 18 and the image pre-processing circuitry 19. For example, the local memory 21 may include random access memory (RAM) and the main memory storage device 22 may include read only memory (ROM), rewritable non-volatile memory such as flash memory, hard drives, optical discs, and the like. By way of example, a computer program product containing the instructions may include an operating system or an application program.

Using the network interface 24, the electronic device 10 may communicatively couple to a network and/or other computing devices. For example, the network interface 24 may connect the electronic device 10 to a personal area network (PAN), such as a Bluetooth network, a local area network (LAN), such as an 802.11x Wi-Fi network, and/or a wide area network (WAN), such as a 4G or LTE cellular network. In this manner, the network interface 24 may enable the electronic device 10 to transmit encoded image data to a network and/or receive encoded image data from the network for display on the electronic display 12.

The processor core complex 18 is operably coupled with I/O ports 16, which may enable the electronic device 10 to interface with various other electronic devices. For example, a portable storage device may be connected to an I/O port 16, thereby enabling the processor core complex 18 to communicate data with a portable storage device. In this manner, the I/O ports 16 may enable the electronic device 10 to output encoded image data to the portable storage device and/or receive encoded image data from the portable storage device.

The power source 26 may include any suitable source of energy, such as a rechargeable lithium polymer (Li-poly) battery and/or an alternating current (AC) power converter. Furthermore, as depicted, the processor core complex 18 is operably coupled with input structures 14, which may enable a user to interact with the electronic device 10. The input structures 14 may include buttons, keyboards, mice, trackpads, and/or the like. Additionally or alternatively, the electronic display 12 may include touch components that enable user inputs to the electronic device 10 by detecting occurrence and/or position of an object touching its screen (e.g., surface of the electronic display 12).

In addition to enabling user inputs, the electronic display 12 may present visual representations of information by display images (e.g., image frames), such as a graphical user interface (GUI) of an operating system, an application interface, a still image, or video content. As described above, the electronic display 12 may display an image based on corresponding image data. In some embodiments, the image data may be received from other electronic devices 10, for example, via the network interface 24 and/or the I/O ports 16. Additionally or alternatively, the image data may be generated by electronic device 10 using the image sensor 13. In some embodiments, image sensor 13 may digitally capture visual representations of proximate physical features as image data.

As described above, the image data may be encoded (e.g., compressed), for example, by the electronic device 10 that generated the image data, to reduce number of memory addresses used to store and/or bandwidth used to transmit the image data. Once generated or received, the encoded image data may be stored in local memory 21. Accordingly, to a display image corresponding with encoded image data, the processor core complex 18 or other image data processing circuitry may retrieve encoded image data from local memory 21, decode the encoded image data, and instruct the electronic display 12 to display image frames based on the decoded image data.

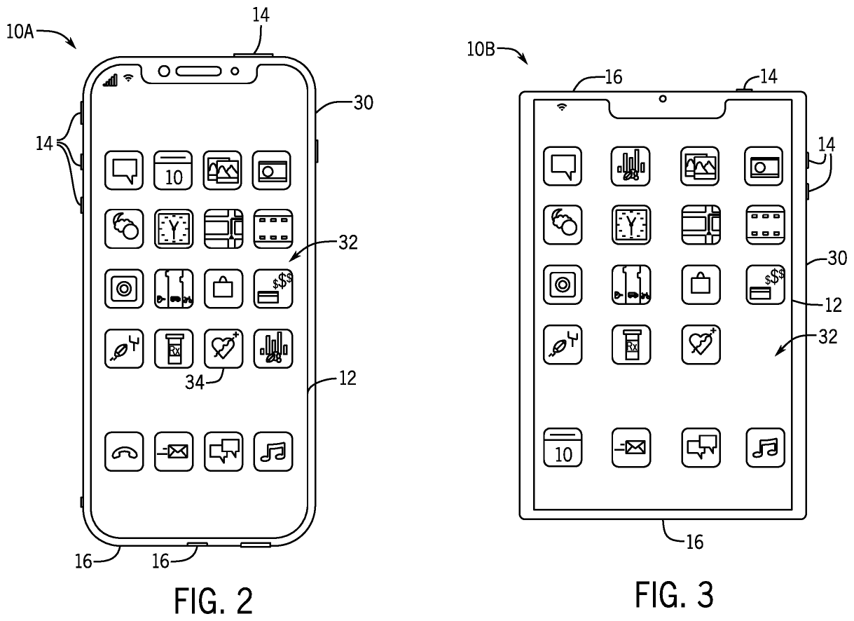

The electronic device 10 may be any suitable electronic device. To help illustrate, one example of a handheld device 10A is described in FIG. 2, which may be a portable phone, a media player, a personal data organizer, a handheld game platform, or any combination of such devices. For example, the handheld device 10A may be a smart phone, such as any iPhone® model available from Apple Inc.

The handheld device 10A includes an enclosure 30 (e.g., housing). The enclosure 30 may protect interior components from physical damage and/or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. The I/O ports 16 may be accessed through openings in the enclosure 30 and may include, for example, an audio jack to connect to external devices.

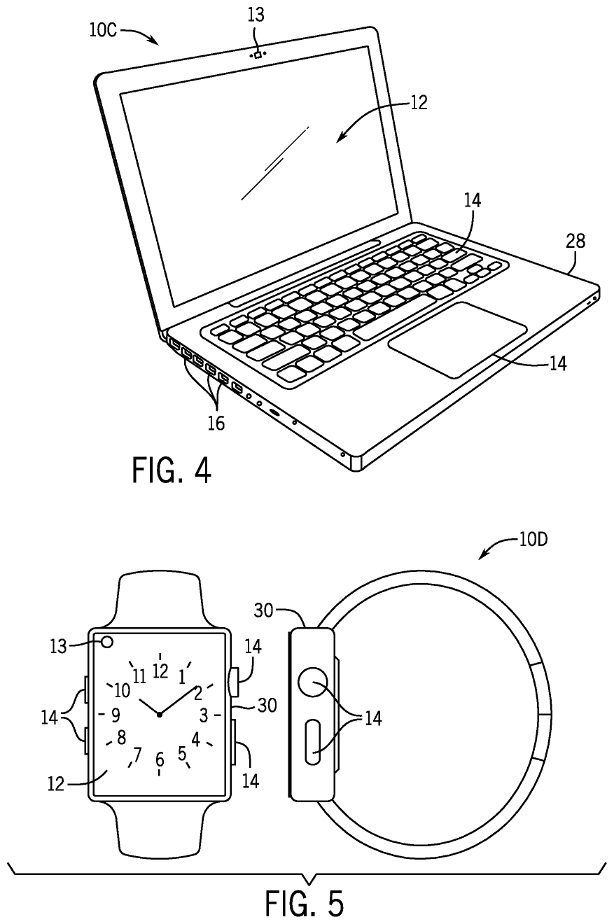

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

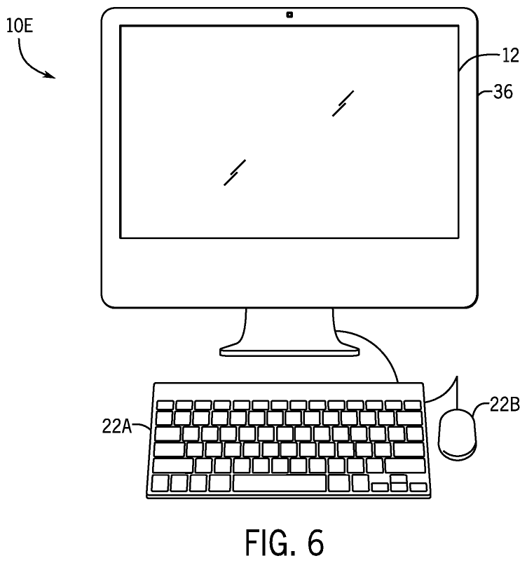

Turning to FIG. 6, a computer 10E may represent another embodiment of the electronic device 10 of FIG. 1. The computer 10E may be any computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input devices 14, such as the keyboard 14A or mouse 14B (e.g., input devices 14), which may connect to the computer 10E.

As described above, source image data may be encoded (e.g., compressed) to reduce resource usage. Additionally, in some embodiments, the duration between generation of image data and display of a corresponding image based on the image data may be limited to enable real-time or near real-time display and/or transmission. For example, image data captured by the image sensor 13 may be displayed on the electronic display 12 with minimal delay to enable a user to determine physical features proximate the image sensor 13 in real-time or near real-time. Additionally, image data generated by the electronic device 10 (e.g., by the image sensor 13) may be transmitted (e.g., broadcast) to one or more other electronic devices 10 to enable a real-time or near real-time streaming. To enable real-time or near real-time transmission and/or display, duration available to encode image data may be limited—particularly as the resolution of images and/or refresh rates of electronic displays 12 increase.

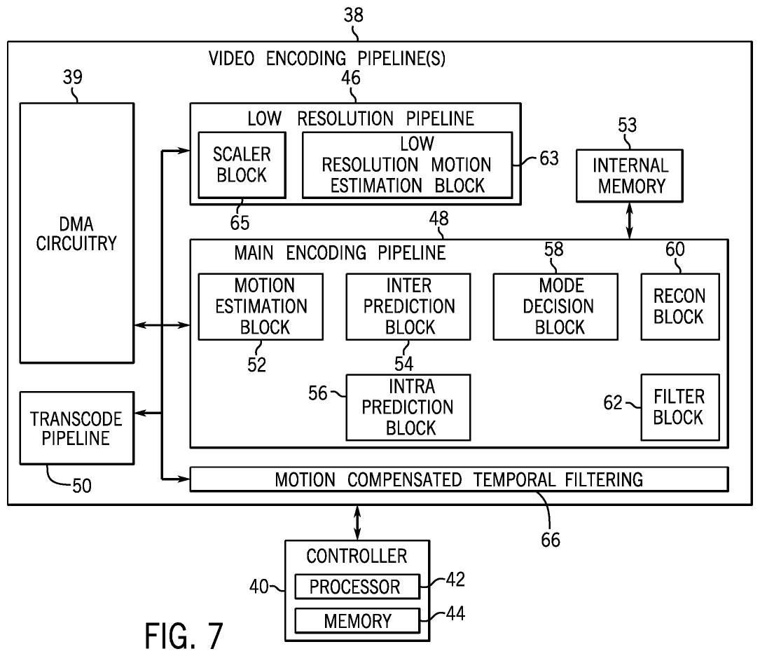

An example of a portion of an electronic device 10, which includes a video encoding system 38, is shown in FIG. 7. The video encoding system 38 may be implemented via circuitry, for example, packaged as a system-on-chip (SoC). Additionally or alternatively, the video encoding system 38 may be included in the processor core complex 18, the image processing circuitry 20, a timing controller (TCON) in the electronic display 12, one or more other processing units, other processing circuitry, or any combination thereof.

The video encoding system 38 may be communicatively coupled to a controller 40. The controller 40 may generally control operation of the video encoding system 38. Although depicted as a single controller 40, in other embodiments, one or more separate controllers 40 may be used to control operation of the video encoding system 38. Additionally, in some embodiments, the controller 40 may be implemented in the video encoding system 38, for example, as a dedicated video encoding controller.

The controller 40 may include a controller processor 42 and controller memory 44. In some embodiments, the controller processor 42 may execute instructions and/or process data stored in the controller memory 44 to control operation of the video encoding system 38. In other embodiments, the controller processor 42 may be hardwired with instructions that control operation of the video encoding system 38. Additionally, in some embodiments, the controller processor 42 may be included in the processor core complex 18, the image processing circuitry 20, and/or separate processing circuitry (e.g., in the electronic display 12), and the controller memory 44 may be included in local memory 21, main memory storage device 22, and/or a separate, tangible, non-transitory computer-readable medium (e.g., in the electronic display 12).

The video encoding system 38 includes direct memory access (DMA) circuitry 39. In some embodiments, the DMA circuitry 39 may communicatively couple the video encoding system 38 to an image sensor, such as external memory that stores source image data, for example, generated by the image sensor 13 or received via the network interface 24 or the I/O ports 16.

To facilitate generating encoded image data, the video encoding system 38 may include multiple parallel pipelines. For example, in the depicted embodiment, the video encoding system 38 includes a low-resolution pipeline 46, a main encoding pipeline 48, and a transcode pipeline 50. The main encoding pipeline 48 may encode source image data using prediction techniques (e.g., inter prediction techniques or intra prediction techniques), and the transcode pipeline 50 may subsequently entropy encode syntax elements that indicate encoding parameters (e.g., quantization coefficient, inter prediction mode, and/or intra prediction mode) used to prediction encode the image data.

To facilitate prediction encoding source image data, the main encoding pipeline 48 may perform various functions. To simplify discussion, the functions are divided between various blocks (e.g., circuitry or modules) in the main encoding pipeline 48. In the depicted embodiment, the main encoding pipeline 48 includes a motion estimation block 52, an inter prediction block 54, an intra prediction block 56, a mode decision block 58, a reconstruction block 60, and a filter block 62.

The motion estimation block 52 is communicatively coupled to the DMA circuitry 39. In this manner, the motion estimation block 52 may receive source image data via the DMA circuitry 39, which may include a luma component (e.g., Y) and two chroma components (e.g., Cr and Cb). In some embodiments, the motion estimation block 52 may process one coding unit, including one luma coding block and two chroma coding blocks, at a time. As used herein a “luma coding block” is intended to describe the luma component of a coding unit and a “chroma coding block” is intended to describe a chroma component of a coding unit.

A luma coding block may be the same resolution as the coding unit. On the other hand, the chroma coding blocks may vary in resolution based on chroma sampling format. For example, using a 4:4:4 sampling format, the chroma coding blocks may be the same resolution as the coding unit. However, the chroma coding blocks may be half (e.g., half resolution in the horizontal direction) the resolution of the coding unit when a 4:2:2 sampling format is used and a quarter (e.g., half resolution in the horizontal direction and half resolution in the vertical direction) the resolution of the coding unit when a 4:2:0 sampling format is used.

As described above, a coding unit may include one or more prediction units, which may each be encoded using the same prediction technique, but different prediction modes. Each prediction unit may include one luma prediction block and two chroma prediction blocks. As used herein a “luma prediction block” is intended to describe the luma component of a prediction unit and a “chroma prediction block” is intended to describe a chroma component of the prediction unit. In some embodiments, the luma prediction block may be the same resolution as the prediction unit. On the other hand, similar to the chroma coding blocks, the chroma prediction blocks may vary in resolution based on chroma sampling format.

Based at least in part on the one or more luma prediction blocks, the motion estimation block 52 may determine candidate inter prediction modes that can be used to encode a prediction unit. An inter prediction mode may include a motion vector and a reference index to indicate location (e.g., spatial position and temporal position) of a reference sample relative to a prediction unit. More specifically, the reference index may indicate display order of a reference image frame corresponding with the reference sample relative to a current image frame corresponding with the prediction unit. Additionally, the motion vector may indicate position of the reference sample in the reference image frame relative to position of the prediction unit in the current image frame.

To determine a candidate inter prediction mode, the motion estimation block 52 may search reconstructed luma image data, which may be previously generated by the reconstruction block 60 and stored in internal memory 53 (e.g., reference memory) of the video encoding system 38. For example, the motion estimation block 52 may determine a reference sample for a prediction unit by comparing its luma prediction block to the luma of reconstructed image data. In some embodiments, the motion estimation block 52 may determine how closely a prediction unit and a reference sample match based on a match metric. In some embodiments, the match metric may be the sum of absolute difference (SAD) between a luma prediction block of the prediction unit and luma of the reference sample. Additionally or alternatively, the match metric may be the sum of absolute transformed difference (SATD) between the luma prediction block and luma of the reference sample. When the match metric is above a match threshold, the motion estimation block 52 may determine that the reference sample and the prediction unit do not closely match. On the other hand, when the match metric is below the match threshold, the motion estimation block 52 may determine that the reference sample and the prediction unit are similar.

After a reference sample that sufficiently matches the prediction unit is determined, the motion estimation block 52 may determine location of the reference sample relative to the prediction unit. For example, the motion estimation block 52 may determine a reference index to indicate a reference image frame, which contains the reference sample, relative to a current image frame, which contains the prediction unit. Additionally, the motion estimation block 52 may determine a motion vector to indicate position of the reference sample in the reference frame relative to position of the prediction unit in the current frame. In some embodiments, the motion vector may be expressed as (mvX, mvY), where mvX is horizontal offset and mvY is a vertical offset between the prediction unit and the reference sample. The values of the horizontal and vertical offsets may also be referred to as x-components and y-components, respectively.

In this manner, the motion estimation block 52 may determine candidate inter prediction modes (e.g., reference index and motion vector) for one or more prediction units in the coding unit. The motion estimation block 52 may then input candidate inter prediction modes to the inter prediction block 54. Based at least in part on the candidate inter prediction modes, the inter prediction block 54 may determine luma prediction samples (e.g., predictions of a prediction unit).

The inter prediction block 54 may determine a luma prediction sample by applying motion compensation to a reference sample indicated by a candidate inter prediction mode. For example, the inter prediction block 54 may apply motion compensation by determining luma of the reference sample at fractional (e.g., quarter or half) pixel positions. The inter prediction block 54 may then input the luma prediction sample and corresponding candidate inter prediction mode to the mode decision block 58 for consideration. In some embodiments, the inter prediction block 54 may sort the candidate inter prediction modes based on associated mode cost and input only a specific number to the mode decision block 58.

The mode decision block 58 may also consider one or more candidate intra predictions modes and corresponding luma prediction samples output by the intra prediction block 56. The main encoding pipeline 48 may be capable of implementing multiple (e.g., 13, 17, 25, 29, 35, 38, or 43) different intra prediction modes to generate luma prediction samples based on adjacent pixel image data. Thus, in some embodiments, the intra prediction block 56 may determine a candidate intra prediction mode and corresponding luma prediction sample for a prediction unit based at least in part on luma of reconstructed image data for adjacent (e.g., top, top right, left, or bottom left) pixels, which may be generated by the reconstruction block 60.

For example, utilizing a vertical prediction mode, the intra prediction block 56 may set each column of a luma prediction sample equal to reconstructed luma of a pixel directly above the column. Additionally, utilizing a DC prediction mode, the intra prediction block 56 may set a luma prediction sample equal to an average of reconstructed luma of pixels adjacent the prediction sample. The intra prediction block 56 may then input candidate intra prediction modes and corresponding luma prediction samples to the mode decision block 58 for consideration. In some embodiments, the intra prediction block 56 may sort the candidate intra prediction modes based on associated mode cost and input only a specific number to the mode decision block 58.

The mode decision block 58 may determine encoding parameters to be used to encode the source image data (e.g., a coding unit). In some embodiments, the encoding parameters for a coding unit may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction units, number of transform units in the coding unit, size of the transform units, whether to split the coding unit into smaller coding units, or any combination thereof.

To facilitate determining the encoding parameters, the mode decision block 58 may determine whether the image frame is an I-frame, a P-frame, or a B-frame. In I-frames, source image data is encoded only by referencing other image data used to display the same image frame. Accordingly, when the image frame is an I-frame, the mode decision block 58 may determine that each coding unit in the image frame may be prediction encoded using intra prediction techniques.

On the other hand, in a P-frame or B-frame, source image data may be encoded by referencing image data used to display the same image frame and/or a different image frames. More specifically, in a P-frame, source image data may be encoding by referencing image data associated with a previously coded or transmitted image frame. Additionally, in a B-frame, source image data may be encoded by referencing image data used to code two previous image frames. More specifically, with a B-frame, a prediction sample may be generated based on prediction samples from two previously coded frames; the two frames may be different from one another or the same as one another. Accordingly, when the image frame is a P-frame or a B-frame, the mode decision block 58 may determine that each coding unit in the image frame may be prediction encoded using either intra techniques or inter techniques.

Although using the same prediction technique, the configuration of luma prediction blocks in a coding unit may vary. For example, the coding unit may include a variable number of luma prediction blocks at variable locations within the coding unit, which each uses a different prediction mode. As used herein, a “prediction mode configuration” is intended to describe the number, size, location, and prediction mode of luma prediction blocks in a coding unit. Thus, the mode decision block 58 may determine a candidate inter prediction mode configuration using one or more of the candidate inter prediction modes received from the inter prediction block 54. Additionally, the mode decision block 58 may determine a candidate intra prediction mode configuration using one or more of the candidate intra prediction modes received from the intra prediction block 56.

Since a coding unit may utilize the same prediction technique, the mode decision block 58 may determine prediction technique for the coding unit by comparing rate-distortion metrics (e.g., costs) associated with the candidate prediction mode configurations and/or a skip mode. In some embodiments, the rate-distortion metric may be determined by summing a first product obtained by multiplying an estimated rate that indicates number of bits expected to be used to indicate encoding parameters and a first weighting factor for the estimated rate and a second product obtained by multiplying a distortion metric (e.g., sum of squared difference) resulting from the encoding parameters and a second weighting factor for the distortion metric. The first weighting factor may be a Lagrangian multiplier, and the first weighting factor may depend on a quantization parameter associated with image data being processed.

The distortion metric may indicate amount of distortion in decoded image data expected to be caused by implementing a prediction mode configuration. Accordingly, in some embodiments, the distortion metric may be a sum of squared difference (SSD) between a luma coding block (e.g., source image data) and reconstructed luma image data received from the reconstruction block 60. Additionally or alternatively, the distortion metric may be a sum of absolute transformed difference (SATD) between the luma coding block and reconstructed luma image data received from the reconstruction block 60.

In some embodiments, prediction residuals (e.g., differences between source image data and prediction sample) resulting in a coding unit may be transformed as one or more transform units. As used herein, a “transform unit” is intended to describe a sample within a coding unit that is transformed together. In some embodiments, a coding unit may include a single transform unit. In other embodiments, the coding unit may be divided into multiple transform units, which is each separately transformed.

Additionally, the estimated rate for an intra prediction mode configuration may include expected number of bits used to indicate intra prediction technique (e.g., coding unit overhead), expected number of bits used to indicate intra prediction mode, expected number of bits used to indicate a prediction residual (e.g., source image data—prediction sample), and expected number of bits used to indicate a transform unit split. On the other hand, the estimated rate for an inter prediction mode configuration may include expected number of bits used to indicate inter prediction technique, expected number of bits used to indicate a motion vector (e.g., motion vector difference), and expected number of bits used to indicate a transform unit split. Additionally, the estimated rate of the skip mode may include number of bits expected to be used to indicate the coding unit when prediction encoding is skipped.

The mode decision block 58 may select a prediction mode configuration or skip mode with the lowest associated rate-distortion metric for a coding unit. In this manner, the mode decision block 58 may determine encoding parameters for a coding unit, which may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction unit, number of transform units in the coding block, size of the transform units, whether to split the coding unit into smaller coding units, or any combination thereof.

To facilitate improving perceived image quality resulting from decoded image data, the main encoding pipeline 48 may then mirror decoding of encoded image data. To facilitate, the mode decision block 58 may output the encoding parameters and/or luma prediction samples to the reconstruction block 60. Based on the encoding parameters and reconstructed image data associated with one or more adjacent blocks of image data, the reconstruction block 60 may reconstruct image data.

More specifically, the reconstruction block 60 may generate the luma component of reconstructed image data. In some embodiments, the reconstruction block 60 may generate reconstructed luma image data by subtracting the luma prediction sample from luma of the source image data to determine a luma prediction residual. The reconstruction block 60 may then divide the luma prediction residuals into luma transform blocks as determined by the mode decision block 58, perform a forward transform and quantization on each of the luma transform blocks, and perform an inverse transform and quantization on each of the luma transform blocks to determine a reconstructed luma prediction residual. The reconstruction block 60 may then add the reconstructed luma prediction residual to the luma prediction sample to determine reconstructed luma image data. As described above, the reconstructed luma image data may then be fed back for use in other blocks in the main encoding pipeline 48, for example, via storage in internal memory 53 of the main encoding pipeline 48. Additionally, the reconstructed luma image data may be output to the filter block 62.

The reconstruction block 60 may also generate both chroma components of reconstructed image data. In some embodiments, chroma reconstruction may be dependent on sampling format. For example, when luma and chroma are sampled at the same resolution (e.g., 4:4:4 sampling format), the reconstruction block 60 may utilize the same encoding parameters as used to reconstruct luma image data. In such embodiments, for each chroma component, the reconstruction block 60 may generate a chroma prediction sample by applying the prediction mode configuration determined by the mode decision block 58 to adjacent pixel image data.

The reconstruction block 60 may then subtract the chroma prediction sample from chroma of the source image data to determine a chroma prediction residual. Additionally, the reconstruction block 60 may divide the chroma prediction residual into chroma transform blocks as determined by the mode decision block 58, perform a forward transform and quantization on each of the chroma transform blocks, and perform an inverse transform and quantization on each of the chroma transform blocks to determine a reconstructed chroma prediction residual. The chroma reconstruction block may then add the reconstructed chroma prediction residual to the chroma prediction sample to determine reconstructed chroma image data, which may be input to the filter block 62.

However, in other embodiments, chroma sampling resolution may vary from luma sampling resolution, for example when a 4:2:2 or 4:2:0 sampling format is used. In such embodiments, encoding parameters determined by the mode decision block 58 may be scaled. For example, when the 4:2:2 sampling format is used, size of chroma prediction blocks may be scaled in half horizontally from the size of prediction units determined in the mode decision block 58. Additionally, when the 4:2:0 sampling format is used, size of chroma prediction blocks may be scaled in half vertically and horizontally from the size of prediction units determined in the mode decision block 58. In a similar manner, a motion vector determined by the mode decision block 58 may be scaled for use with chroma prediction blocks.

To improve quality of decoded image data, the filter block 62 may filter the reconstructed image data (e.g., reconstructed chroma image data and/or reconstructed luma image data). In some embodiments, the filter block 62 may perform deblocking and/or sample adaptive offset (SAO) functions. For example, the filter block 62 may perform deblocking on the reconstructed image data to reduce perceivability of blocking artifacts that may be introduced. Additionally, the filter block 62 may perform a sample adaptive offset function by adding offsets to portions of the reconstructed image data.

To enable decoding, encoding parameters used to generate encoded image data may be communicated to a decoding device. In some embodiments, the encoding parameters may include the encoding parameters determined by the mode decision block 58 (e.g., prediction unit configuration and/or transform unit configuration), encoding parameters used by the reconstruction block 60 (e.g., quantization coefficients), and encoding parameters used by the filter block 62. To facilitate communication, the encoding parameters may be expressed as syntax elements. For example, a first syntax element may indicate a prediction mode (e.g., inter prediction mode or intra prediction mode), a second syntax element may indicate a quantization coefficient, a third syntax element may indicate configuration of prediction units, and a fourth syntax element may indicate configuration of transform units.

The transcode pipeline 50 may then convert a bin stream, which is representative of syntax elements generated by the main encoding pipeline 48, to a bit stream with one or more syntax elements represented by a fractional number of bits. In some embodiments, the transcode pipeline 50 may compress bins from the bin stream into bits using arithmetic coding. To facilitate arithmetic coding, the transcode pipeline 50 may determine a context model for a bin, which indicates probability of the bin being a “1” or “0,” based on previous bins. Based on the probability of the bin, the transcode pipeline 50 may divide a range into two sub-ranges. The transcode pipeline 50 may then determine an encoded bit such that it falls within one of two sub-ranges to select the actual value of the bin. In this manner, multiple bins may be represented by a single bit, thereby improving encoding efficiency (e.g., reduction in size of source image data). After entropy encoding, the transcode pipeline 50, may transmit the encoded image data to an output for transmission, storage, and/or display.

Additionally, the video encoding system 38 may include motion compensated temporal filtering circuitry 66, which may perform further motion vector refinement operations and perform temporal filtering operations on the refined motion vectors received from the main encoding pipeline 48 and the low-resolution pipeline 46. The motion compensated temporal filtering circuitry 66 may receive motion vectors from the main encoding pipeline 48, the low-resolution pipeline 46, or both, and may fetch source pixels and reference pixels based on the received motion vectors. Additionally, the motion compensated temporal filter block 66 may perform motion vector refinement based on the received motion vectors and fetched source pixels and reference pixels. The motion compensated temporal filter block 66 may use the refined motion vectors to perform temporal filtering operations by calculating a weighted average of the source and reference pixels to determine filtered pixel values for the video image data, and transmit the filtered encoded image data to the output for transmission, storage, and/or display.

Furthermore, the video encoding system 38 may be communicatively coupled to an output. In this manner, the video encoding system 38 may output encoded (e.g., compressed) image data to such an output, for example, for storage and/or transmission. Thus, in some embodiments, the local memory 21, the main memory storage device 22, the network interface 24, the I/O ports 16, the controller memory 44, or any combination thereof may serve as an output.

As described above, the duration provided for encoding image data may be limited, particularly to enable real-time or near real-time display and/or transmission. To improve operational efficiency (e.g., operating duration and/or power consumption) of the main encoding pipeline 48, the low resolution pipeline 46 may include a scaler block 65 and a low resolution motion estimation (ME) block 63. The scaler block 65 may receive image data and downscale the image data (e.g., a coding unit) to generate low-resolution image data. For example, the scaler block 65 may downscale a 32×32 coding unit to one-sixteenth resolution to generate an 8×8 downscaled coding unit. In other embodiments, such as embodiments in which the pre-processing circuitry 19 generates image data (e.g., low-resolution image data) from source image data, the low resolution pipeline 46 may not include the scaler block 65, or the scaler block 65 may not be utilized to downscale image data.

The low resolution motion estimation block 63 may improve operational efficiency by initializing the motion estimation block 52 with candidate inter prediction modes, which may facilitate reducing searches performed by the motion estimation block 52. Additionally, the low resolution motion estimation block 63 may improve operational efficiency by generating global motion statistics that may be utilized by the motion estimation block 52 to determine a global motion vector.

### Motion Compensated Temporal Filtering

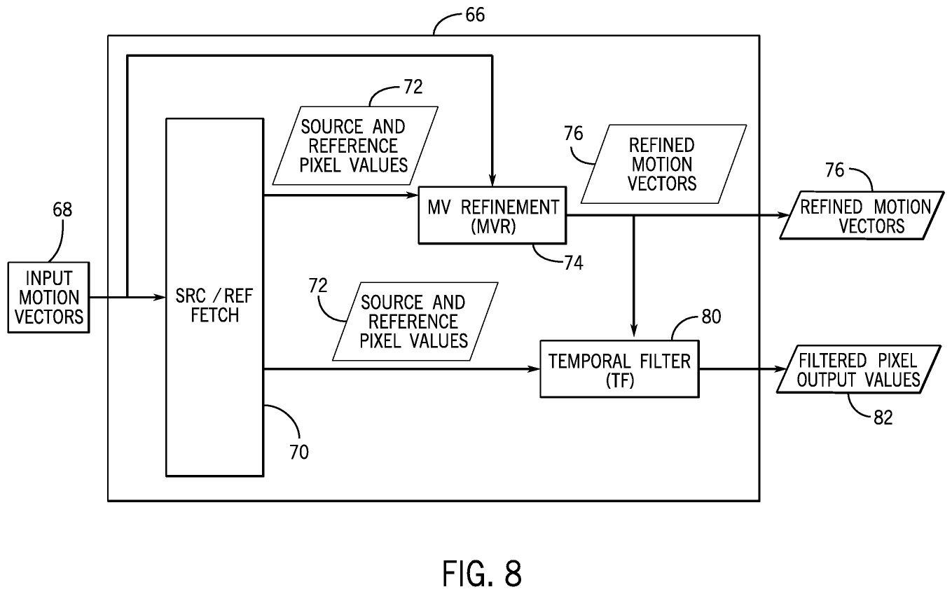

To help elaborate on performing motion compensated temporal filtering, the motion compensated temporal filtering circuitry 66 is shown in FIG. 8. The motion compensated temporal filtering circuitry 66 may receive input motion vectors 68 that include motion vectors produced during main encoding pipeline operations 48 and the low-resolution pipeline 46. The input motion vectors 68 may be used by a source and reference fetch block 70 to determine source pixel values and reference pixel values corresponding to the input motion vectors 68. Source and reference pixel values 72 determined by the source and reference fetch block 70 may be sent to a motion vector refinement block 74 and used to refine motion vectors. A temporal filter block 80 may receive the refined motion vectors 76 from the motion vector refinement block 74 along with the source and reference pixel values 72. The temporal filter 80 may then filter the source and reference pixel values 72 (e.g., based on or using the refined motion vectors 76) to produce filtered pixel output values 82. The motion compensated temporal filtering circuitry 66 may output the refined motion vectors 76 and the filtered pixel output values 82.

As discussed above, the source and reference fetch block 70 receives input motion vectors 68. The input motion vectors 68 may be received from the DMA circuitry 39, the main encoding pipeline 48, the low-resolution pipeline 46, or any other component of the electronic device 10. The source and reference fetch block 70 includes hardware that determines source and reference pixels based on the input motion vectors 68. The source and reference pixels may be utilized during motion vector refinement block 74 and the temporal filter block 80 operations. The source and reference fetch block 70 may fetch the source pixels corresponding to the current CTU of the input motion vectors 68. The CTU may be 32×32 pixels and include 16×16 block of Chroma pixels per component. The source and reference fetch block 70 may also fetch source pixels outside the CTU. This may include an additional row of pixels (e.g., additional 33 pixels) and a column of luma pixels (e.g., 32 luma pixels) that may be above the current CTU. This may determine the 33×33 source luma block that will be used in later motion vector refinement and temporal filtering operations. Additionally, for each chroma component determined by the search and reference fetch block 70, an additional row and column of chroma pixels may be used above and to the left of the CTU. This may result in a block of pixels (e.g., a 17×17 block) that is up-sampled from the CTU block of pixels (e.g., a 34×34 block).

The search and reference fetch block 70 may use the motion vectors to determine the exact location of the reference chroma pixels (e.g., 4×4 block) to be fetched that correspond to the luma pixel block. The fetched chroma pixels full-pel position may be off by a half-pel distance relative to the fetched luma full-pel position. The refined chroma pixels may be a distance away from both an even and/or odd motion vector in the center of the fetched chroma full-pel position. The maximum distance from chroma full-pel position may be −1.25 to 1.75 pixels, or any suitable maximum distance for use in temporal filtering. The reference chroma pixel may be fetched in 8×8 blocks at a time including surrounding 2 pixels on all four sides of the 8×8 blocks, or based on any suitable chroma block size. Additionally, the motion vectors may be used to determine blocks to be fetched for the reference luma pixels. The reference luma pixels are fetched in certain number of blocks at a time, including the additional surrounding pixels. The blocks selected by the refined motion vector may be at the center of the CTU block.

The source pixels and reference pixels 72 may be sent to the motion vector refinement block 74. The motion vector refinement block 74 up samples the luma pixels with bilinear interpolation, such that the reference frame corresponds to a smaller block size (e.g., a 28×28 block). In the case of a block located on the frame boundary, the nearest boundary pixels may be repeated to fill out boundary values within the block.

The motion vector refinement block 74 determines the current best motion vector from the received motion vectors 68 and refines the motion vector around a size window (e.g., ±1.5) for sub-pel precision. The refinement of the received motion vectors 68 may be completed in 8×8 pixel blocks. The motion vector refinement block may consider a certain number of motion vectors based on the source pixel block size. For example, an 8×8 source pixel block corresponds to forty-nine motion vectors for consideration. To complete the sub-pel refinement for each of the 8×8 blocks, bilinear interpolation is completed using the source and reference pixel blocks. The cost for each motion vector may be determined based on the smoothness of the motion vector in light of surrounding motion vectors, and the difference between the luma source and reference pixels (e.g., a sum of absolute difference (SAD)). The resulting motion vectors are determined to be refined motion vectors 76 by the motion vector refinement block 74.

The temporal filter block 80 receives the refined motion vectors 76, and filters each source pixel along with the corresponding reference pixels determined by the refined motion vectors 76. The filtering may be carried out on a pixel-by-pixel basis. For example, the temporal filter block 80 may utilize lookup tables (LUTs) to replace the inverse computations for pixel difference, motion vector difference, and infinite image response (IIR) weight. The pixel weight and motion vector weight (e.g., 0-4) for each LUT may be set for each reference image frame. The temporal filtering block 80 may perform a filtering operation by calculating a weighted combination of the source pixels and reference pixels. The weight may be determined by multiplying together different weights to get the final weight. For example, the weights that are multiplied together may be a pixel weight determined per pixel, a motion weight per pixel block, and an IIR weight per pixel block. In other embodiments, block-based weights may be derived by the motion vector refinement block 74, and may be sent to the temporal filter block 80. The filtered pixel values output 82 and the refined motion vectors 76 may be output and sent to the DMA circuitry 39, image display circuitry, or sent back into the motion compensation temporal filtering circuitry 66 to be used as neighbor reference values.

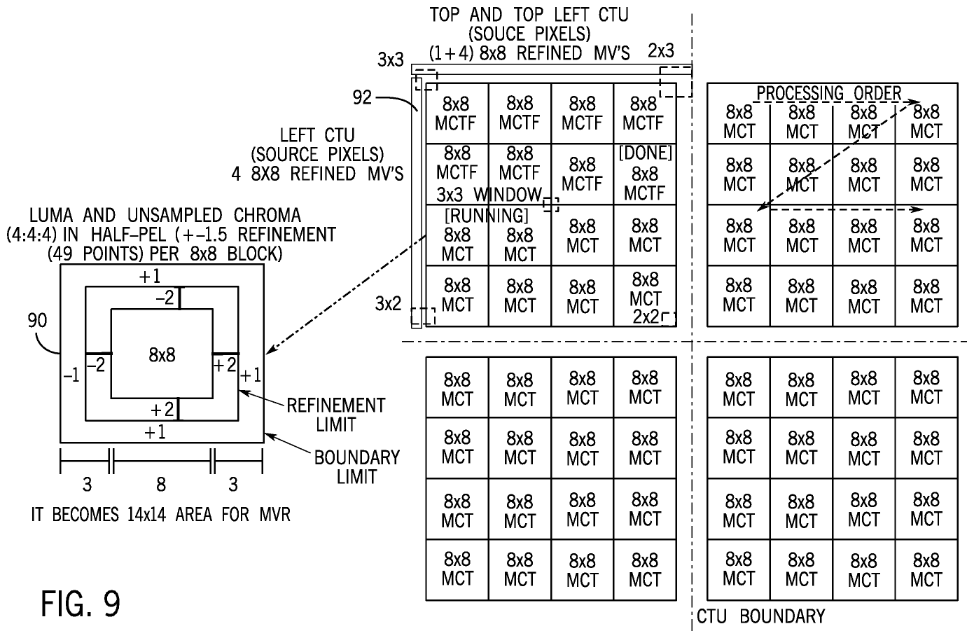

Keeping the foregoing in mind, FIG. 9 is a diagrammatic representation of motion vector refinement of received motion vectors, in accordance with an embodiment. The motion vector refinement block 74 may refine received motion vectors using corresponding source and reference pixel values received from the source and reference fetch block 70. The motion vector refinement block 74 may refine a received motion vectors 76 of the source pixel block 92 around a specified window (e.g., ±1.5) in sub-pel precision. The refinement may include selecting the lowest cost motion vector out of considered motion vectors for each of the 8×8 source pixel blocks. The cost may be calculated by using bilinear interpolation and determining differences between source and reference pixel values.

The motion vector refinement block 74 may refine the motion vectors in the source pixel blocks 92 (e.g., 8×8 pixel blocks, 16×16 pixel blocks, 32×32 pixel blocks). For each source pixel block 90 a total number of motion vectors relative to the block size may be considered. To perform the sub-pel refinement of the motion vectors of each 8×8 block 90, bilinear interpolation may be completed on the source pixel blocks. The cost for each of the candidate motion vectors may be determined based on determining the difference between the source pixels and reference pixels for each of the source pixel blocks. Each of the source pixel blocks 90 may include luma pixel values and up-sampled chroma pixel values in half-pel precision (e.g., forty-nine points per 8×8 block). The motion vector refinement network may include multiple source pixel blocks that include multiple CTU source pixel units 92. The cost of each source pixel block 90 is computed by determining the difference between the source pixel values and reference pixel values is computed. Additionally, the cost computation may include determining a lambda motion vector term that may be an unsigned fixed-point multiplier that balances the distortion within the source pixel block with a penalty motion vector term. The penalty motion vector term may measure the smoothness of the current motion vector under consideration relative to the neighboring motion vectors.

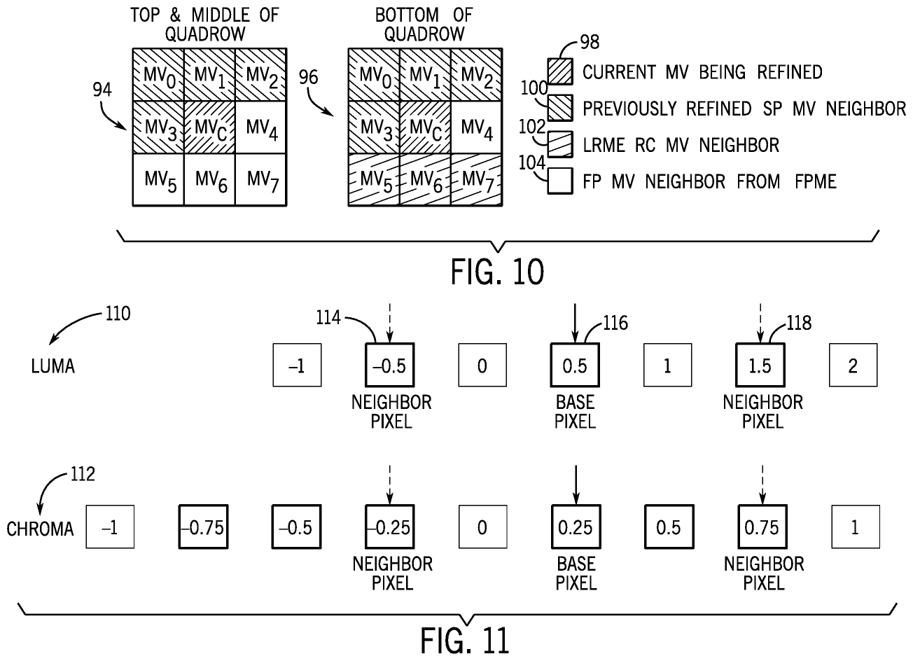

With the foregoing in mind, FIG. 10 is diagrammatic representation of motion vector refinement using motion vector neighbor blocks. As discussed above, the motion vector refinement may include computing a cost of each candidate motion vector. The cost computation may include a penalty component that enables evaluation of a candidate vector relative to the neighboring motion vectors. For example, the top and middle of the pixel block quadrow 94 may include a current motion vector 98, along with previously refined motion vectors 100 neighboring the current motion vector 98, and full-pipeline motion estimation vectors 102 neighboring the current motion vector 98.

The bottom of the quadrow 96 of the pixel block may include the current motion vector 98 that is being refined, along with the previously refined motion vectors 100 neighboring the current motion vector, the full-pipeline motion estimation vectors 102 neighboring the current motion vector 98, and low-resolution pipeline motion estimation vectors 104. For each of the candidate current motion vector 98 there may be eight neighbor vectors that may be represented as MVᵢ, where i=0, . . . , 7. The analysis may use the most recently defined motion vector if available when analyzing the current motion vector 98 and determining a penalty calculation for the cost computation. If no recently defined motion vector is available, the previously refined motion vectors 100, the full-pipeline motion vectors 102, and the low-resolution motion vectors 104 should be utilized for the penalty calculation in the prior referenced order.

After computing the cost, the motion vector that results in the lowest cost is selected as the refined motion vector to be used in the temporal filter block 80. The temporal filter block 80 may utilize the refined motion vectors 76 along with the source and reference pixel values 72 to filter the source pixel values. For example, FIG. 11 is a diagrammatic representation of luma pixel value 110 and chroma pixel value calculations 112 for temporal filtering of pixel values, in accordance with an embodiment. The temporal filter block 80 filters each of the source pixels and the corresponding reference pixels based on the refined motion vectors.

The input data received at the temporal filter block 80 may include the luma pixels 110 and the chroma pixels 112 fetched by the source and reference fetch block 70, block values corresponding to the refined motion vectors, and averaged pixel data from source and reference frames used in the motion vector refinement of FIG. 9. The pixels, including luma and chroma values, may be contained within a 3×3 window. The luma pixel 110 values within the 3×3 window may be full-pel distance from the base pixel value 116. Further, the chroma pixel 112 values may be a half-pel distance from the base pixels 116. The pixels displayed may include luma 110 and chroma pixel 112 values. The base pixel 116 and neighbor pixels 114 may be bilinear interpolated pixels with two adjacent full-pel pixels, in the case of the luma pixels 110. The resulting input pixel values may be filtered, by performing a weighted combination of the source pixels and reference pixels. The output filtered pixels may be used to display video images that include temporal filtering for motion trajectories.

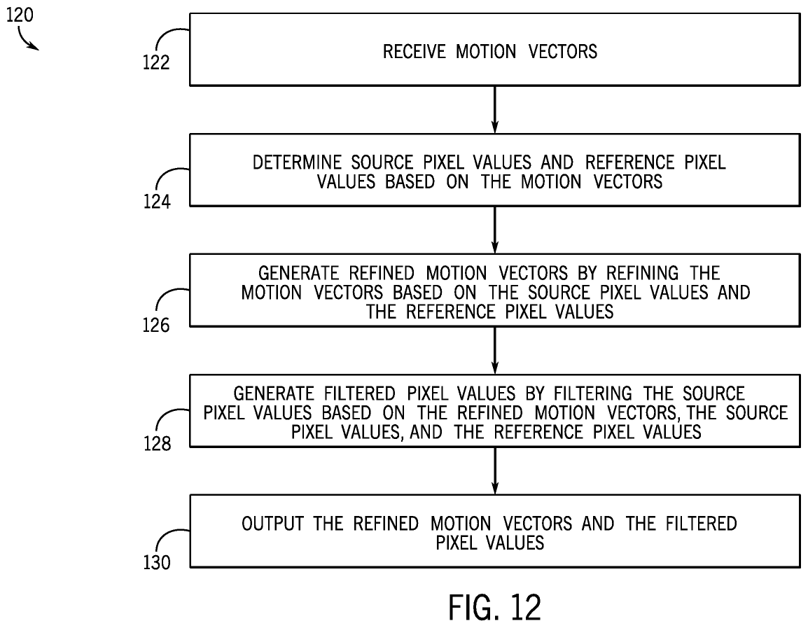

With the foregoing in mind, FIG. 12 is a flow diagram of a process 120 of motion compensated temporal filtering operations, in accordance with an embodiment. The motion compensated temporal filtering circuitry 66 may operate to receive motion vectors from the full-resolution pipeline 48 and the low-resolution pipeline 46, and refine the motion vectors and apply temporal filtering along motion trajectories. The motion compensated temporal filtering circuitry 66 may refine the received motion vectors 68, and may utilize the received motion vectors 68 to filter the source pixels to produce final output pixels that include temporal filtering based on the refined motion vectors.

The motion compensated temporal filtering circuitry 66, at process block 122, receives motion vectors 68 from the low-resolution pipeline 46 and the full-resolution pipeline 48 of video encoding system 38. The received motion vectors 68 may be received at the source and reference fetch block 70, along with the motion vector refinement block 74. The motion compensated temporal filtering circuitry 66, at process block 124, determines source pixel values and reference pixel values 72 based on the received motion vectors 68. For instance, referring briefly to FIG. 8, as discussed above, the motion compensated temporal filtering circuitry 66 may include source and reference fetch block 70 that fetches the corresponding source and reference pixel values 72 based on the received motion vectors 68. The source and reference fetch block 70 may send the fetched source pixels and reference pixel values 72 to the motion vector refinement block 74 along with the temporal filter block 80. The source pixels and reference pixel values 72 are used to facilitate refinement of the motion vectors, along with the filter coefficient calculation based on the window around each of the filtered pixels.

Returning to FIG. 12 and the discussion of the process 120, the motion compensated temporal filtering circuitry 66, at process block 126, generates the refined motion vectors 76 by refining the received motion vectors 68 based on the fetched source pixel values and the reference pixel values 72. The motion compensated temporal filtering circuitry 66 may include motion vector refinement block 74 that may select the best received motion vectors 68 and refine the motion vectors around a specified window in sub-pel resolution. The refinement may take place in certain pixel size block units. The refined motion vectors may then be sent to temporal filtering circuitry.

The motion compensated temporal filtering circuitry 66, at process block 128, generates the filtered pixel values output 82 by filtering the source pixel values based on the refined motion vectors, source pixel values, and the reference pixel values. More specifically, the temporal filter block 80 may perform filtering operations using the corresponding reference pixel blocks from all active reference frames in filtering the source pixel block. At process block 130, the motion compensated temporal filtering circuitry 66 outputs the refined motion vectors 76 and the filtered pixel values output 82. The final output may be the filtered pixel values output 82 and the refined motion vectors 75 of all the active reference pixel values.

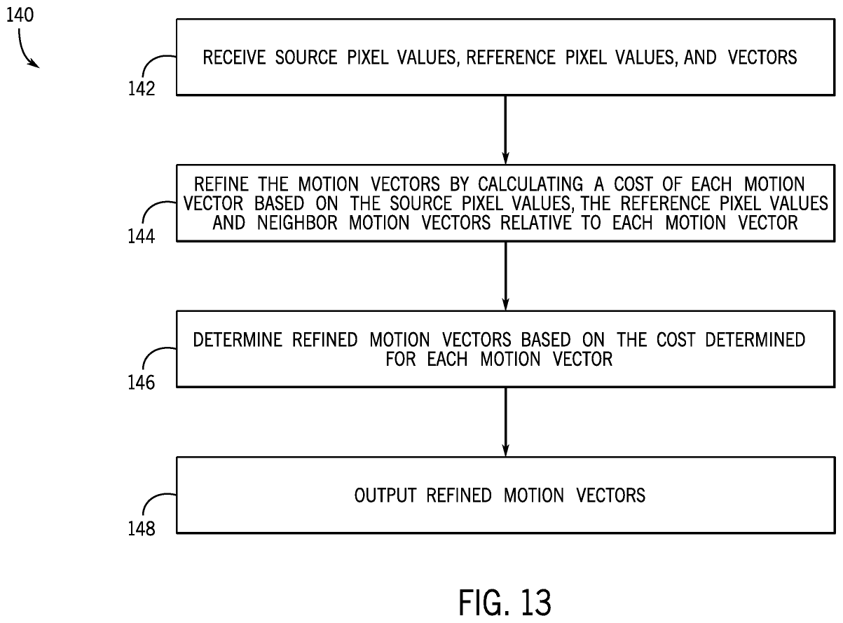

With the foregoing in mind, FIG. 13 is a flow diagram of a process 140 of motion vector refinement operations, in accordance with an embodiment. The process 140 may be performed by the motion vector refinement block 74 that receives the motion vectors from the full-resolution pipeline 48 and the low-resolution pipeline 46 of the video encoding system 38. Additionally, the motion vector refinement block 74 receives the source pixels and reference pixel values 72 from the source and reference fetch block 70. The motion vector refinement block 74 may refine the best candidate motion vectors around a specific window in sub-pel precision. Accordingly, the process 140 may be performed at process block 126 of the process 120.

The motion vector refinement block 74, at process block 142, receives the source pixel values, and the reference pixel values 72, and the input motion vectors 68. As discussed above, the motion vector refinement block 74 receives the input motion vectors 68 from the full-resolution pipeline 48 and the low-resolution pipeline 46 of the video encoding system 38. Additionally, the motion vector refinement block 74 receives the source pixels and reference pixel values 72 from the source and reference fetch block 70.

The motion vector refinement block 74, at process block 144, may refine the input motion vectors 68 by calculating a cost of each motion vector based on the source pixel values, the reference pixel values 72, and the neighbor motion vectors relative to each motion vector. The motion vector refinement block 74 may up-sample the reference luma pixels with bilinear interpolation. Additionally, the motion vector refinement block 74 may select a current best candidate motion vector from the full-pipeline motion vectors and refine the best candidate motion vector around a certain window size (e.g., ±1.5) in sub-pel precision. The refinement of the full-resolution pipeline motion vectors may be carried out in pixel blocks. For example, the pixel blocks may be 8×8 pixel blocks, 16×16 pixel blocks, 32×32 pixel blocks, or any suitable pixel block size. For each source pixel block, a certain number of motion vectors are considered. For example, an 8×8 source pixel block may include forty-nine motion vectors that are considered. When considering the best candidate motion vector from the motion vectors, the cost per each motion vector may be evaluated. The luma difference between the source pixel blocks and the reference blocks may be calculated, along with a penalty motion vector value that measures the smoothness of the motion vector that is evaluated relative to its neighboring motion vectors. There may be eight neighbor motion vectors in the example of the 8×8 source pixel block.

The most recently refined motion vector may be used for the penalty calculation if available. If the most recently refined motion vector is not available, the full-resolution pipeline motion vector should be used, followed by the low-resolution motion vector. Additionally, if the CTU is on a frame boundary, some of the neighboring blocks may not be available. In this case, the unavailable neighbors are replaced by the nearest available neighbor block by extension and/or duplication. The motion vector refinement block 74, at process block 146, may determine the refined motion vectors 76 based on the cost determined for each motion vector. For example, for each 8×8 source pixel block, a cost per each candidate motion vector may be calculated, and the motion vector that results in the lowest cost may be chosen as the final refined motion vector 76. In some cases, the cost may be the same between motion vectors and the motion vector with the smallest length may be chosen as the refined motion vector. If there is a tie in cost of the motion vectors and length of the motion vectors, the order of the refinement vectors may be order in raster order, and the motion vector that is sorted first is selected as the refined motion vector. The motion vector refinement block 74, at block 148, outputs the refined motion vectors 76 (e.g., for an entire pixel block or a portion thereof). Additionally, the refined motion vectors 76 may be received by the temporal filter block 80.

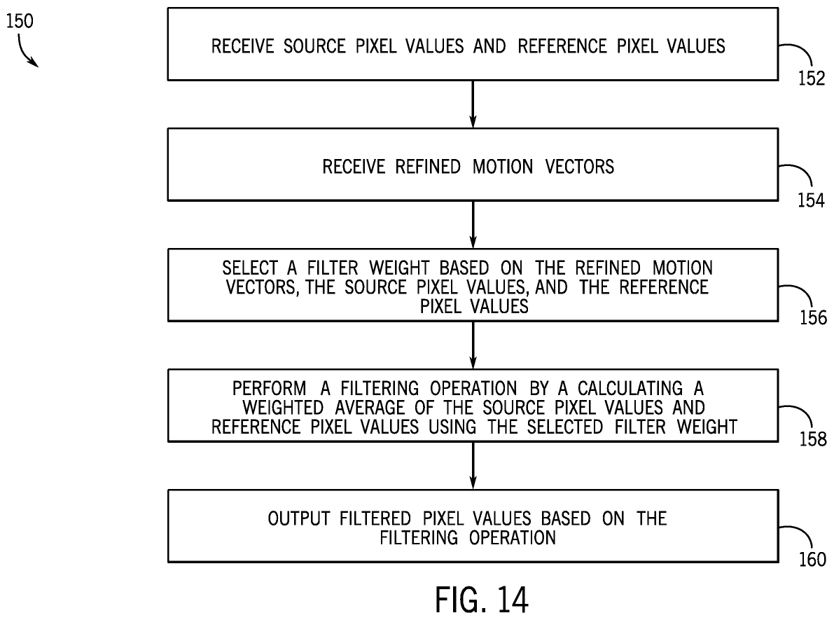

With the foregoing in mind, FIG. 14 is a flow diagram of a process 150 for performing temporal filtering. The temporal filter block 80 may filter each source pixel value with the corresponding reference pixel values determined by the refined motion vectors 76. Accordingly, the temporal filter block 80 may perform the process 150. Additionally, the process 150 may be performed at process block 128 of the process 120.

At process block 142, the temporal filter block 80 receives source pixel values and reference pixel values from the source and reference fetch block 70. The temporal filter block 80, at block 154, receives the refined motion vectors 76 output from the motion vector refinement block 74. The input data needed for each 8×8 source pixel block may include the 8×8 luma pixel block corresponding to the lowest cost determined during motion vector refinement. Additionally, the averaged motion vector of nine 8×8 blocks in a 3×3 window centered on the current block. The neighbor motion vectors within the block may be the same as the ones used during the motion vector refinement and the centered motion vector is the refined motion vector determined during motion vector refinement. The input data per pixel may include the averaged pixel values from the source and reference frames in the 3×3 window.

The temporal filter block 80, at block 156, selects a filter weight based on the refined motion vectors, the source pixel values, and the reference pixel values. The temporal filter block 80 may use look-up-tables (LUTs) to replace the inverse computations for pixel difference, motion difference, and IIR weight. The temporal filter block 80, at block 158, performs a filtering operation by calculating the weighted average of the source pixel values and reference pixel values using the selected filter weight. The filtering operation may be a weighted combination of the source pixels and the reference pixels. There may be three weights that are multiplied to compute the final weight including the pixel weight, the motion weight, and the IIR weight. In some embodiments, block-based weights may be derived using the motion vector refinement block 74 that may be sent to the temporal filter block 80. The output of the filtered pixel values output 82 may be used to display the video image and/or stored in the memory.

### Low-Resolution Motion Estimation Techniques

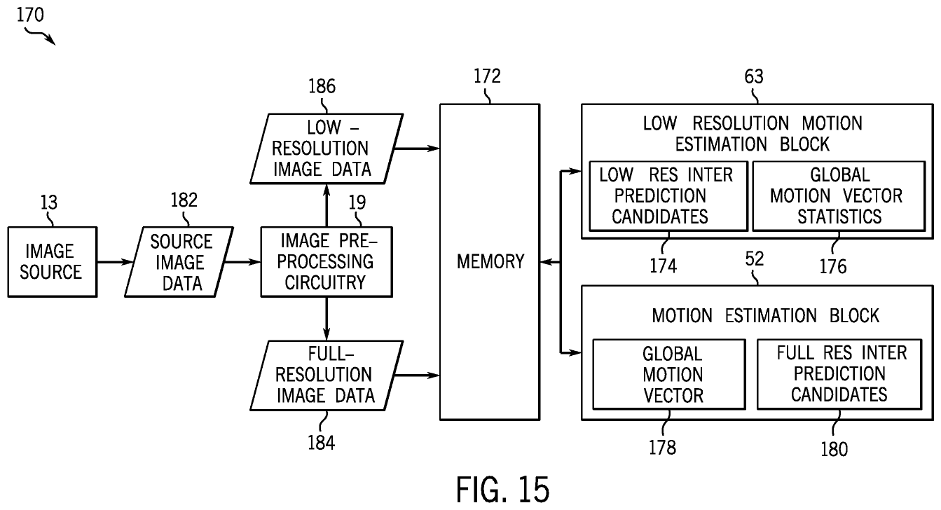

As noted above, the present disclosure relates to low-resolution motion estimation techniques. Motion estimation techniques may be utilized on scaled (e.g., downscaled) image data. As described above, scaled image data may be generated by the scaler block 65 of the low-resolution motion pipeline. In other embodiments, the scaled image data may be generated by other circuitry included in the electronic device 12. To help illustrate, FIG. 15 is a block diagram of a portion 170 of the video encoding system 38, which includes the low resolution motion estimation block 63 and the motion estimation block 52 coupled to external memory 172, along with the image sensor 13, the image pre-processing circuitry 19, and various types of image data (e.g., source image data 182, full-resolution image data 184, and low-resolution image data 186). In some embodiments, the external memory 172 may be a tangible, non-transitory, computer-readable medium accessible by the video encoding system 38, for example, to store data and/or retrieve data, such as image data and/or statistics data. Accordingly, in some embodiments, the external memory 172 may be included in the controller memory 44, the local memory 21, or the main memory storage device 22. In other embodiments, the external memory 172 may be a separate storage component dedicated to the video encoding system 38. Furthermore, it should be noted that the image pre-processing circuitry 19 may be included in the video encoding system 38.

The external memory 172 is communicatively coupled to the low resolution motion estimation block 63 and the motion estimation block 52 of the main encoding pipeline 48. In some embodiments, the external memory 172 may provide direct memory access (DMA) that enables the low resolution motion estimation block 63 and the main encoding pipeline 48 to access the external memory 172 relative independently. Thus, in such embodiments, the low resolution motion estimation block 63 may process image frames in advance of the main encoding pipeline 48, which may enable the low resolution motion estimation block 63 to determine information (e.g., low resolution candidate inter prediction modes and/or motion vector statistics) useful for the main encoding pipeline 48, particularly the motion estimation block 52 and the mode decision block 58.

For example, the low resolution motion estimation block 63 may analyze low resolution image data to determine one or more low resolution inter prediction mode candidates 174, which may be analyzed as full resolution inter prediction mode candidates 180 by the motion estimation block 52. To facilitate improving operational efficiency, in some embodiments, the low resolution motion estimation block 63 may prune the low resolution inter prediction mode candidates 174 before they are evaluated by the motion estimation block 52, for example, to consolidate low resolution inter prediction mode candidates 174 that indicate similar motion vectors.

Additionally or alternatively, the low resolution motion estimation block 63 may determine global motion vector statistics 176 based at least in part on the low resolution inter prediction mode candidates 174. In some embodiments, the global motion vector statistics 176 determined by the low resolution motion estimation block 63 may facilitate image stabilization. Additionally, in some embodiments, the low resolution motion estimation block 63 may determine similar portions of successively displayed images to determine trends in motion, for example, as a global motion vector. Based on the motion trends, successively displayed image frames may be stabilized. In this manner, the low resolution motion estimation block 63 may determine the global motion vector statistics 176 that are useful for improving operational efficiency of the main encoding pipeline 48 and, thus, may facilitate real-time or near real-time transmission and/or display of image data.

Furthermore, the low resolution inter prediction mode candidates 174 and global motion vector statistics 176 may be utilized by the motion estimation block 52 of the video encoding system 38 to determine a global motion vector 178 and full resolution inter prediction mode candidates 180. In some embodiments, the global motion vector 178 may be indicative of motion trends across multiple image and, thus, may be used by the motion estimation block 52 to improve the evaluated full resolution inter prediction mode candidates 180, for example, by offsetting a full resolution inter prediction mode candidate to compensate for the motion trend.

The inter prediction block 54 may determine luma prediction samples and chroma prediction samples by applying each of the full resolution inter prediction mode candidates 180. Additionally, as described above, the mode decision block 58 may consider one or more candidate intra predictions modes, corresponding luma prediction samples, and corresponding luma prediction samples to determine a candidate intra prediction mode, a corresponding luma prediction sample, and corresponding chroma prediction samples for a prediction unit, which the reconstruction block 60 may use to generate reconstructed image data.

Continuing with the discussion of FIG. 15, to help describe an example of how image data may be encoded, the low resolution motion estimation block 63 and the motion estimation block 52 may perform several operations such as determining candidate low resolution inter prediction modes (e.g., via the low resolution motion estimation block 63), determining global motion vector statistics 176 based on the candidate low resolution inter prediction modes (e.g., via the low resolution motion estimation block 63), determining the global motion vector 178 (e.g., via the motion estimation block 52 based on the global motion vector statistics 176), and determining an inter prediction mode based on the global motion vector and the candidate low resolution inter prediction modes 174 (e.g., via the motion estimation block 52). Such operations may be implemented at least in part based on circuit connections formed (e.g., programmed) in the video encoding system 38. Additionally or alternatively, these operations may be implemented at least in part by executing instructions stored in a tangible non-transitory computer-readable medium, such as the controller memory 44, using processing circuitry, such as the controller processor 42. Some image data encoding techniques are described in more detail in U.S. patent application Ser. No. 16/032,925, entitled “Global Motion Vector Video Encoding Systems and Methods,” which is hereby incorporated by reference in its entirety for all purposes.

Generally, the operations mentioned above could be performed utilized image data generated from the source image data 182. For instance, as mentioned above, the low resolution motion estimate block 63 may generate downscaled image data from the source image data 182. However, for certain types of source image data 182 (e.g., relatively higher resolution source image data), utilizing the low resolution motion estimation block 63 to scale source image data 182 may be burdensome (e.g., utilize high amounts of power and/or processing resources) and utilize relatively large amounts of the memory 172. To enable more of the resources of the low resolution motion estimation block 63 to be utilized for encoding techniques (e.g., determining low resolution inter prediction candidates 174 and global motion vector statistics 176) and to reduce the amount of bandwidth of the memory 172 being utilized, the image pre-processing circuitry 19 may be utilized to generate image data (e.g., full-resolution image data 184 and low-resolution image data 186) from the source image data 182 that can be stored in the memory 172 and utilized by the low resolution motion estimation block 63 and the motion estimation block 52. By doing so, the video encoding system 38 may be able to encode image data more quickly and efficiently. Some techniques for generating the full-resolution image data 184 and low-resolution image data 186 from the source image data 182 that can be stored in the memory 172 and utilized by the low resolution motion estimation block 63 and the motion estimation block 52 are described in more detail in U.S. patent application Ser. No. 17/020,750, entitled “Systems and Methods for Encoding Image Data,” which is hereby incorporated by reference in its entirety for all purposes.

As noted above, to encode image data, the low resolution motion estimation block 63 and the motion estimation block 52 may perform several operations such as determining candidate low resolution inter prediction modes (e.g., via the low resolution motion estimation block 63), determining global motion vector statistics 176 based on the candidate low resolution inter prediction modes (e.g., via the low resolution motion estimation block 63), determining the global motion vector 178 (e.g., via the motion estimation block 52 based on the global motion vector statistics 176), and determining an inter prediction mode based on the global motion vector and the low resolution inter prediction mode candidates 174 (e.g., via the motion estimation block 52). It should also be noted that the motion estimation block 52 may utilize low resolution inter prediction mode candidates 174 that the low resolution motion estimation block 63 may generate by performing a recursive search.

Before discussing the recursive search, it should be noted that the low resolution motion estimation block may perform motion estimation searches using luma or both luma and chroma. That is, downscaled image data (e.g., low-resolution image data 186) generated from the source image data 182 may be generated from the luma component of the source image data 182 or both the luma and chroma components of the source image data 182. In particular, utilizing both luma and chroma may enable more accurate motion vectors (e.g., motion vector candidates) to be determined, which may enable more accurate prediction modes to be selected. In other words, by utilizing both luma and chroma when performing low resolution motion estimation searches, the motion vectors may be more representative of motion across images (e.g., frames of a video). For instance, in content in which an object in the image and the background have similar brightnesses (e.g., luma), utilizing chroma (e.g., color) may enable image processing circuitry to better determine motion (e.g., of the object) across frames of the image content even for content in which the object is a similar color to the background. Accordingly, by performing low resolution motion estimation searches using luma and chroma, more accurate motion vectors and, thus, prediction modes (e.g., intra prediction modes) may be realized compared to techniques that only utilize luma.

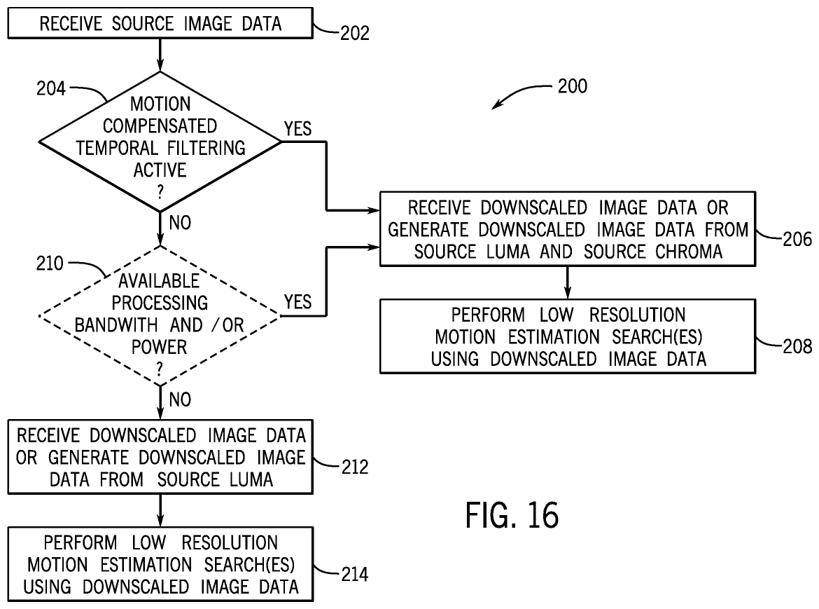

To help provide more context, FIG. 16 is provided. In particular, FIG. 16 is a flow diagram of a process 200 for scaling image data and performing low-resolution motion estimation searches (e.g., using only luma or both luma and chroma) on the scaled image data. Generally, the process 200 includes receiving source image data (process block 202), determining whether motion compensated temporal filtering is active (decision block 204), and, when motion compensated temporal filtering is active, receiving downscaled image data or generating the downscaled image data from source luma and source chroma (process block 206) and performing one or more low-resolution motion estimation searches using the downscaled image data (process block 208). When motion compensated temporal filtering is not active, the process 200 may optionally include determining whether there is available processing bandwidth, power, or both (decision block 210). When there is available processing bandwidth, power (e.g., battery life), or both, the process 200 may also include the operations discussed above with respect to process block 206 and process block 208. When motion compensated temporal filtering is not active (and, in embodiments including decision bock 210, when there is not available processing bandwidth, power, or both), the process 200 may include receiving downscaled image data or generating the downscaled image data from source luma (process block 212) and performing one or more low-resolution motion estimation searches using the downscaled image data (process block 214) generated from the source luma. In some embodiments, the process 200 may be implemented at least in part based on circuit connections formed (e.g., programmed) in the video encoding system 38. Additionally or alternatively, the process 200 may be implemented at least in part by executing instructions stored in a tangible non-transitory computer-readable medium, such as the controller memory 44, using processing circuitry, such as the controller processor 42.

At process block 202, the low resolution pipeline 46 may receive source image data, such as the source image data 182 generated by the image sensor 13. More specifically, in embodiments in which the scaler block 65 scales (e.g., downscales) image data, the low resolution pipeline 46 may receive the source image data 182. In embodiments in which the image pre-processing circuitry 19 is utilized to scale image data, the image pre-processing circuitry 19 may receive the source image data 182.

The video encoding system 38 may select between a mode of operation in which luma is considered and another mode of operation in which both luma and chroma are considered when generating motion vectors, motion vector candidates, and determining how to encode image data. Keeping this in mind, at decision block 204, the controller processor 42 may determine whether motion compensated temporal filtering is active. If motion compensated temporal filtering is active, the video encoding system 38 may be considered to be operating in a first mode of operation. At process block 206, in embodiments in which the image pre-processing circuitry generates the low-resolution image data 186, the controller processor 42 may cause the low resolution motion estimation block 63 to receive (e.g., by retrieving from the memory 172) downscaled image data, such as the low-resolution image data 186. In embodiments in which the scaler block 65 downscales image data, at process block 206, the controller processor 42 may cause the scaler block 65 to generate the downscaled image data, which may be the low-resolution image data 186.

Before continuing with the discussion of the process 200, it should be noted that the downscaled image data received or generated at process block 206 is generated based on the luma and chroma of the source image data 182. In other words, a frame (e.g., image) of the source image data 182 may include a coding unit that includes coding blocks. For example, as noted above, the coding block may include a luma coding block and two chroma coding blocks. Accordingly, the low resolution image data 186 generated from the source image data 182 may include downscaled coding blocks such as a downscaled luma prediction block that corresponds to a luma prediction block in the luma coding blocks and downscaled chroma prediction blocks that correspond to chroma prediction blocks of the chroma coding blocks.

At process block 208, the low resolution motion estimation block 63 may perform one or more low-resolution motion estimation searches using the downscaled image data (e.g., low resolution image data 186) generated or received at process block 206. The motion estimation searches may include those discussed below with respect to recursive searches. From performing the low-resolution motion estimation searches, the low resolution motion estimation block 63 may generate or determine downscaled reference samples and motion vector candidates. The motion vector candidates are each indicative of a respective location of one of the downscaled reference samples. As discussed above (and below), the motion estimation block 52 may receive low resolution motion vector candidates generated by the low resolution motion estimation block 63 and utilize the low resolution motion vector candidates to determine encoding parameters to be used to encode the source image data 182 (or the full resolution image data 184). Accordingly, the low resolution motion estimation block 63 may generate motion vectors based on luma components and chroma components of image data, and the motion vectors may be utilized when determining how to encode the image data.

Continuing with the discussion of the process 200, if motion compensated temporal filtering is inactive (as determined at decision block 204), at decision block 210, the controller processor 42 may determine whether there is sufficient data processing bandwidth, available power, or both data processing bandwidth, available power. For example, there may be a threshold processing bandwidth value that may be equivalent to a percentage (e.g., 25%, 50%, 75%, 90%, or any suitable percentage value greater than 0%) of a maximum process bandwidth of the video encoding system 38 or a portion thereof (e.g., the low resolution pipeline 46, the low resolution motion estimation block 63, the main encoding pipeline 48, the motion estimation block 52, or a combination thereof). When the available processing bandwidth is greater than or equal to the threshold, the controller processor 42 may determine that there is sufficient data processing bandwidth. Similarly, there may be an available power threshold. For instance, in embodiments, in which the power source 26 of the electronic device 10 is a battery, the available power threshold may be a percentage value (e.g., 25%, 50%, 75%, 90%, or any suitable percentage value greater than 0%) of remaining battery life of the power source 26. Additionally, a power mode of the electronic device 10 as well as whether the power source 26 is charging may be considered. Based on these three factors (or a portion thereof), the controller processor 42 may determine whether there is sufficient power available. For instance, in one embodiment, if the power source 26 is charging, the controller processor 42 may determine that there is sufficient available power regardless of the power mode or remaining battery life of the power source 26. In another embodiment, when the power source 26 is not being charged, and the electronic device 10 is operating in a reduced power mode (e.g., to conserve battery power), the controller processor 42 may determine that there is not sufficient available power regardless of the amount of remaining battery life of the power source 26. In another embodiment, when the power source 26 is not being charged and the electronic device 10 is not operating in a power mode that conserves power, the controller processor 42 may determine that there is sufficient power available when the power available (e.g., remaining battery life) is greater than or equal or the available power threshold.

When there is sufficient available processing bandwidth, power, or both (as determined at decision block 210), the controller processor 42 may cause the operations discussed above with respect to process block 206 and process block 208 to occur. However, when there is insufficient available processing bandwidth, power, or both (as determined at decision block 210), the video encoding system 38 may be considered to be operating in a second mode of operation. At process block 212, in embodiments in which the image pre-processing circuitry generates the low-resolution image data 186, the controller processor 42 may cause the low resolution motion estimation block 63 to receive (e.g., by retrieving from the memory 172) downscaled image data, such as the low-resolution image data 186. In embodiments in which the scaler block 65 downscales image data, at process block 212, the controller processor 42 may cause the scaler block 65 to generate the downscaled image data, which may be the low-resolution image data 186. The downscaled image data generated or received at process block 212 may only include image data generated from the luma component of the source image data 182.

It should be noted that decision block 210 may not be performed in some embodiments. In such embodiments, if motion compensated temporal filtering is inactive (as determined at decision block 204), the video encoding system 38 may be considered to be operating in a second mode of operation, and the process 200 may proceed to process block 212 (discussed below).

At process block 214, the low resolution pipeline 46 may receive source image data, such as the source image data 182 generated by the image sensor 13. More specifically, in embodiments in which the scaler block 65 scales (e.g., downscales) image data, the low resolution pipeline 46 may receive the source image data 182. In embodiments in which the image pre-processing circuitry 19 is utilized to scale image data, the image pre-processing circuitry 19 may receive the source image data 182.

As noted above, recursive searching may be utilized to perform the low resolution motion estimation searches described above with respect to process block 208 and process block 214. Before discussing the recursive search in the context of a process for determining low resolution inter prediction candidates (e.g., low resolution inter prediction mode candidates 174), it should be noted that the recursive search may be used in addition to another search (e.g., a first search). Alternatively, the searches may be considered a single search that includes multiple passes, with the recursive search corresponding to one or more passes that are performed after an initial pass of the search. In particular, the first pass may generate motion vectors or low resolution inter prediction mode candidates 174 that fit a particular criterion or criteria (e.g., minimized rate-distortion metrics), and the successive pass(es) corresponding to the recursive search may refine the output of the first pass to help generate a smoother motion field that may be more representative of true motion relative to the output of the first pass. Accordingly, by performing the recursive search discussed herein, the low resolution motion estimation block 63 may generate low resolution inter prediction mode candidates 174 that may be more accurate of motion in image data and improve the accuracy of the determination of full resolution inter prediction modes by the motion estimation block 52.

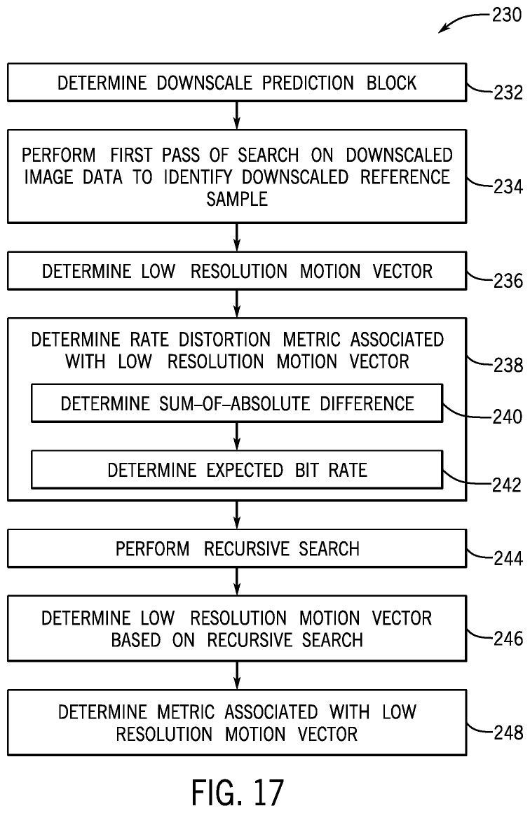

Bearing this in mind, FIG. 17 is a flow diagram of a process 230 for determining a candidate low resolution inter prediction mode. Generally, the process 230 includes determining a downscaled prediction block (process block 232), searching downscaled reference image data to identify a downscaled reference sample (process block 234), determining a low resolution motion vector based on location of the downscaled reference sample (process block 236), and determining a rate-match metric associated with the low resolution motion vector (process block 238), performing a recursive search (process block 244), determining a lower resolution motion vector based on the recursive search (process block 246), and determining a metric associated with the low resolution motion vector (process block 248). In some embodiments, the process 230 may be implemented at least in part based on circuit connections formed (e.g., programmed) in the video encoding system 38. Additionally or alternatively, the process 230 may be implemented at least in part by executing instructions stored in a tangible non-transitory computer-readable medium, such as the controller memory 44, using processing circuitry, such as the controller processor 42.

Accordingly, in some embodiments, a controller 40 may instruct the low resolution motion estimation block 63 to determine a downscaled prediction block (process block 232). For example, in the second mode of operation, the low resolution motion estimation block 63 may process a downscaled coding unit, such as a downscaled luma coding block. Additionally, as described above, a coding unit may include one or more prediction units, such as a luma prediction block and/or a chroma prediction block. In the first mode of operation, the low resolution motion estimation block 62 may process a downscaled luma coding block and one or more downscaled chroma coding blocks.

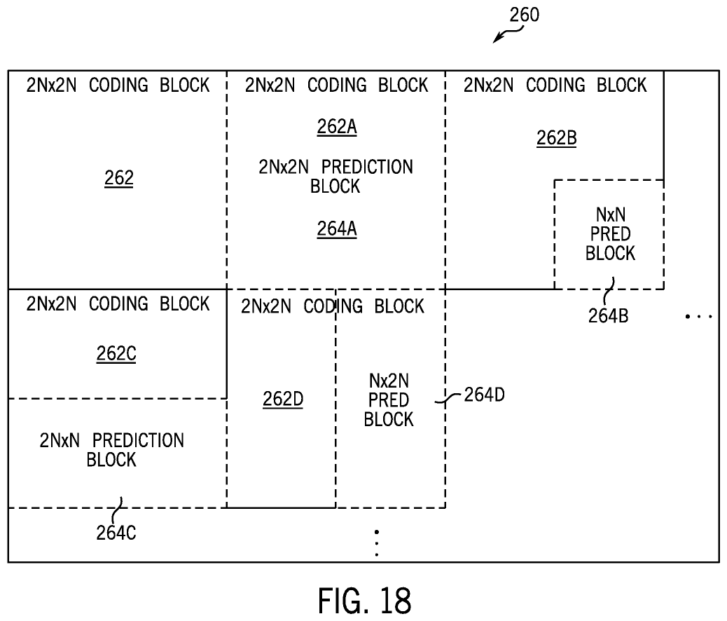

To help illustrate, a diagrammatic representation of an image 260 divided into coding blocks and prediction blocks is shown in FIG. 18. In particular, the image 260 is divided into 2N×2N coding blocks 262. For example, the 2N×2N coding blocks 262 may be 32×32 coding blocks. Additionally, as depicted, each 2N×2N coding block 262 is divided into one or more prediction blocks 264. In one embodiment, luma coding blocks may be 2N×2N coding blocks, while chroma coding blocks may be 2N×N, N×2N, or N×N coding blocks.

In some embodiments, the prediction blocks 264 may be of various sizes or dimensions. For example, a first coding block 262A may include a 2N×2N prediction block 264A, a second coding block 262B may include four N×N prediction blocks 264B, a third coding block 262C may include two 2N×N prediction blocks 264C, and a fourth coding block 262D may include two N×2N prediction blocks 264D. In other words, when the 2N×2N coding blocks 262 are 32×32 coding blocks, the 2N×2N prediction block 264A may be a 32×32 prediction block, the N×N prediction blocks 264B may each be a 16×16 prediction block, the 2N×N prediction blocks 264C may each be a 32×16 prediction block, and the N×2N prediction blocks 264D may each be a 16×32 prediction block.

Additionally, as noted above, a low resolution motion estimation block 63 may downscale coding blocks and, thus, prediction blocks within the coding blocks. In some embodiments, the low resolution motion estimation block 63 may downscale (e.g., down sample or sub-sample) in a horizontal direction and/or a vertical direction. For example, when downscaled by a factor of four in both the horizontal direction and the vertical direction, a 32×32 (e.g., 2N×2N) coding block may result in an 8×8 downscaled coding block. Additionally, a 16×16 (e.g., N×N) prediction block may result in a 4×4 downscaled prediction block, a 32×16 (e.g., 2N×N) prediction block may result in an 8×4 downscaled prediction block, and a 16×32 (e.g., N×2N) prediction block may result in a 4×8 downscaled prediction block. In this manner, a low resolution motion estimation block 63 may determine one or more downscaled prediction blocks.

Returning to the process 230 of FIG. 17, the low resolution motion estimation block 63 may perform a first pass of a search on downscaled image data corresponding with a reference image to identify one or more downscaled reference samples, which may be used to predict the downscaled prediction block (process block 234). In some embodiments, the downscaled reference image data may be previously downscaled source image data, for example, corresponding to other image frames. In other words, the downscaled source image data corresponding with the downscaled prediction block may be searched when the low resolution motion estimation block 63 subsequently processes another image.

In any case, in some embodiments, the low resolution motion estimation block 63 may search the downscaled reference image data to determine one or more downscaled reference samples that are similar to luma or chroma (e.g., in the first mode of operation) or luma (e.g., in the second mode of operation) of the downscaled prediction block. In some embodiments, the low resolution motion estimation block 63 may determine a degree of matching between a downscaled reference sample and the downscaled source image data corresponding with the downscaled prediction block. For example, the low resolution motion estimation block 63 may determine a match metric, such as sum of absolute difference (SAD) between luma of the downscaled prediction block and luma of the downscaled reference sample.

As described above, a coding unit may include one or more luma prediction blocks and one or more chroma prediction blocks, which may each encoded using the same prediction technique. Additionally, as described above, a coding unit may utilize various prediction mode configurations (e.g., number, size, location, and/or prediction modes for the one or more luma prediction blocks and chroma prediction blocks). Thus, in such embodiments, the low resolution motion estimation block 63 may determine one or more downscaled reference samples for variously sized downscaled prediction blocks in a downscaled coding block.

After a downscaled reference sample is determined, the low resolution motion estimation block 63 may determine a motion vector (e.g., a low resolution motion vector) that indicates location of the downscaled reference sample relative to the downscaled prediction block (process block 236). As described above, a motion vector may indicate spatial position of a reference sample in the reference image frame relative to a prediction unit in the current image frame. Additionally, the reference sample may include blocks of image data that form a prediction block. Accordingly, in some embodiments, the low resolution motion estimation block 63 may determine a motion vector by determining a horizontal offset (e.g., mvX) and a vertical offset (e.g., mvY) between a prediction unit corresponding with the downscaled luma prediction block (or downscaled chroma block) and a reference sample corresponding with a downscaled reference sample. In this manner, the low resolution motion estimation block 63 may determine one or more low resolution inter prediction mode (e.g., motion vector and reference index) candidates 174.

Additionally, the low resolution motion estimation block 63 may determine a rate-match metric associated with one or more identified motion vectors (process block 238). In some embodiments, motion vector candidates may be sorted based on associated rate-match metrics (e.g., costs). In some embodiments, the rate-match metric may be determined by summing a first product and a second product. The first product may be determined by multiplying a weighting factor by an estimated rate that indicates number of bits expected to be used to indicate a motion vector candidate (e.g., based at least in part on motion vector difference). The weighting factor may be a Lagrangian multiplier, and the weighting factor may depend on a quantization parameter associated with image data being processed. The second product may be determined by multiplying another weighting factor by a match metric (e.g., sum of absolute difference) associated with a reference sample identified by the motion vector candidate.

The match metric may be indicative of matching degree between source image data and the reference sample identified by the motion vector candidate. As described above, in some embodiments, the match metric may be the sum of absolute difference (SAD) and/or the sum of absolute transformed difference (SATD) between a luma prediction block and luma of the reference sample and, thus, indicative of full resolution matching degree. Additionally or alternatively, the match metric may be the sum of absolute difference (SAD) and/or the sum of absolute transformed difference (SATD) between a downscaled luma prediction block and luma of a downscaled reference sample and, thus, indicative of downscaled matching degree. In the first mode of operation, the match metric may be the sum of absolute difference (SAD) and/or the sum of absolute transformed difference (SATD) between a chroma prediction block and chroma of the reference sample. Additionally or alternatively, the match metric may be the sum of absolute difference (SAD) and/or the sum of absolute transformed difference (SATD) between a downscaled chroma prediction block and chroma of a downscaled reference sample and, thus, indicative of downscaled matching degree.

Thus, in some embodiments, determining the one or more rate-match metrics may include determining one or more sum-of-absolute differences (process sub-block 240) and determining one or more expected bit rates of one or more motion vectors in the one or more inter prediction modes (process sub-block 242). For instance, the low resolution motion estimation block 63 may determine one or more sum-of-absolute differences between luma of downscaled source image data and luma of one or more downscaled prediction blocks 264 or one or more sum-of-absolute difference between chroma of downscaled source image data and chroma of one or more downscaled prediction blocks (process sub-block 240). Additionally, the low resolution motion estimation block 63 may determine estimated rate of one or more motion vectors in the one or more low resolution inter prediction modes (process sub-block 242). As described above, the estimated rate may include number of bits expected to be used to indicate the motion vector. Thus, the estimated rate may depend at least in part on how the motion vector is expected to be indicated. In some embodiments, the motion vector may be transmitted as a motion vector difference, which indicates change in horizontal offset and change in vertical offset from a previously transmitted motion vector. In such embodiments, the estimated rate of the motion vector may be the number of bits expected to be used to transmit the motion vector difference.

To help refine low resolution motion vectors (e.g., as determined at process block 236 based on the first pass of the search), the low resolution motion estimation block 63 may perform a recursive search (process block 244), which may be one or more additional passes of the search performed (e.g., after performing the first pass of the search at process block 234). For example, the recursive search may include one, two, three, four, or more passes of the search that are done in addition to the first pass performed at process block 234.

Each pass of the recursive search may utilize the output of the preceding pass and forming motion vector candidates based on neighboring block results. In particular, each pass of the recursive search may progress in a top-to-bottom, left-to-right manner or a bottom-to-top, right-to-left manner. In the top-to-bottom, left-to-right manner, a pass may begin with a top-left block and progress down a leftmost column of blocks. After reaching the bottom block of the leftmost column, the search may continue from a top block of a second column that is adjacent (e.g., to the right) to the leftmost column in a similar manner. In the bottom-to-top, right-to-left manner, a pass may begin with a bottom-right block and progress up a rightmost column of blocks. After reaching the top block of the rightmost column, the search may continue from a bottom block of a second column that is adjacent (e.g., to the left) to the rightmost column in a similar manner. Each block may be an N×N block of downscaled image data.

For a given block being considered, the motion vectors from neighboring blocks (e.g., as considered during the first pass or the preceding pass) form a set of search vectors use for the block being considered. As discussed below, various types of candidates may be considered during the recursive search. In one embodiment, the recursive search includes four passes in which each pass utilizes one of the types of the candidates discussed below. Accordingly, the recursive search may utilize any combination of the searches that utilize any combination of the candidates discussed below.

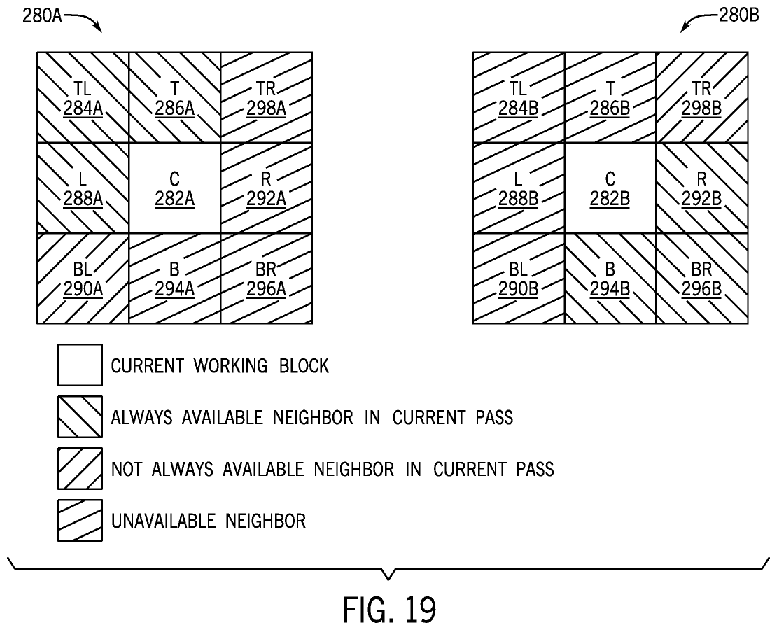

A first type of candidate is called a “spatial candidate.” Spatial candidates are taken from a set of up to four possible neighbors, which are dependent upon the manner of traversal (e.g., top-to-bottom, left-to-right manner or bottom-to-top, right-to-left manner). For example, as illustrated in FIG. 19, in the top-to-bottom, left-to-right manner (as represented by block 280A), for a current block 282A being considered, a top-left block 284A, top block 286A, and left block 288A will be available regardless of the position of the current block 282A (e.g., relative to the search area). A bottom-left block 290A will generally be available as well except in cases in which the current block 282A is located on the bottom row of the search area. When searching in the left-most column of blocks, previous pass candidates (discussed below) may be used. Additionally, the unavailable neighboring blocks may include right block 292A, bottom block 294A, bottom-right block 296A, and top right block 298A.

When progressing in the bottom-to-top, right-to-left manner (as illustrated by block 280B), with block 282B being considered, right block 292B, bottom block 294B, and bottom-right block 296B will be available, and top-right block 298B may be available in most cases (e.g., except for when the block 282B is in a top row or right-most column). When block 282B is located in the right-most column, previous pass candidates may be used instead. As also illustrated, top-left block 284B, top block 286B, left block 288B, and bottom-left block 290B may be unavailable. In other modes of progressing through blocks, other techniques other than utilizing previous pass candidates may be used when a neighboring candidate is unavailable. For example, a different block may be used by offsetting a position indicating a neighboring candidate that is unavailable. If the offset still results in an invalid candidate, previous pass candidates may be utilized instead.

A second type of candidate is called a “previous pass candidate.” Previous pass candidates are taken from the previous pass (e.g., a previous pass of the recursive search). In embodiments in which pervious pass candidates utilize results from a previous pass of the recursive search, the first pass of the recursive search (e.g., a second pass of the overall search) may not utilize previous pass candidates. To account for instances in which a block currently being considered is located along a border of a search window, offset positions may be calculated so that a valid neighboring block exists for each possible position of a block currently under consideration.

A third type of candidate is called a “full search candidate.” Full search candidates include the output of the first pass, and in some cases motion vectors may be scaled (e.g., by a factor of two in both the horizontal and vertical direction). Because full search candidates are generated based on a previously conducted pass (i.e., the first pass), a valid neighboring candidate block exists in each neighboring position surrounding the block currently being evaluated.

A fourth type of candidate is called a “zero candidate,” which corresponds to a zero vector. In other words, the zero candidate corresponds to a (0, 0) motion vector.

When performing the passes of the recursive search, duplicate candidates may be removed from a list of candidates to be considered. Duplicate candidates may include candidates having a same horizontal portion of a motion vector, a same vertical portion of a motion vector, and a same metric value. Here, the metric value may be calculated by summing two submetrics, one in the horizontal direction and one in the vertical direction. The submetrics may be determined by determining the minimum absolute difference between the current block and the neighboring blocks for each horizontal and vertical motion vector. That is, a horizontal submetric may be determined by determining the minimum absolute difference between the current block and the neighboring block for each horizontal motion vector, and the vertical submetric may be determined by determining the minimum absolute difference between the current block and the neighboring block for each vertical motion vector. For such a determination, if the current frame being evaluated in on the edge of the frame, candidates that are outside of the frame may be excluded. In other words, only blocks that are available and inside of the frame may be utilized to determining the values of the submetrics.

In some cases, when accessing motion vectors, the motion vectors may be modified based on a random or pseudorandom number. For example, the horizontal value (e.g., an X value) and the vertical value (e.g., a Y value) of a motion vector may be modified based on a lookup table that defines an adjustment value (e.g., a value between −3 and 3, inclusive) for a position of a block within a search window.

Returning to FIG. 17 and the discussion of the process 230, the low resolution motion estimation block 63 may determine a motion vector (e.g., a low resolution motion vector) that indicates location of the downscaled reference sample relative to the downscaled prediction block (process block 246). As described above, a motion vector may indicate spatial position of a reference sample in the reference image frame relative to a prediction unit in the current image frame. Additionally, the reference sample may include blocks of image data that form a prediction block. Accordingly, in some embodiments, the low resolution motion estimation block 63 may determine a motion vector by determining a horizontal offset (e.g., mvX) and a vertical offset (e.g., mvY) between a prediction unit corresponding with the downscaled luma prediction block and a reference sample corresponding with a downscaled reference sample. In this manner, the low resolution motion estimation block 63 may determine one or more low resolution inter prediction mode (e.g., motion vector and reference index) candidates 174.

Additionally, the low resolution motion estimation block 63 may determine a metric associated with one or more identified motion vectors (process block 248). In one embodiment, the metric may correspond to a SAD for a motion vector or the SAD added the metric value discussed above with respect to duplicate candidates (or a value generated based on the matric metric value discussed above). In some embodiments, motion vector candidates may be sorted based on associated the metric that is determined at process block 248.

Utilizing the low resolution inter prediction candidates 174 and global motion vector statistics generated utilizing the low-resolution image data 186, the motion estimation block 52 may encode the full-resolution image data 184 utilizing techniques discussed above. Accordingly, image data may be encoded by utilizing motion vectors generated from performing the recursive search.

Accordingly, the technical effects of the present disclosure include improving operational efficiency of a video encoding system used to encode (e.g., compress) source image data as well as improving the accuracy of motion estimation. Accordingly, video encoding systems utilizing the techniques described herein may have enhanced accuracy, efficiency, or both.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A video encoding system configured to encode source image data corresponding with an image, the video encoding system comprising:
a low resolution pipeline configured to receive the source image data corresponding with a plurality of coding blocks of a coding unit in the image, wherein the plurality of coding blocks comprises a luma coding block and a chroma coding block, wherein the low resolution pipeline comprises a low resolution motion estimation block configured to:
generate a plurality of downscaled coding blocks in downscaled image data generated from the source image data by downscaling resolution of the source image data corresponding with the plurality of coding blocks, wherein the plurality of downscaled coding blocks comprises:
a downscaled luma prediction block corresponding with a luma prediction block in the luma coding block; and
a downscaled chroma prediction block corresponding with a chroma prediction block in the chroma coding block; and
perform one or more low resolution motion estimation searches based on the luma prediction block and the chroma prediction block to determine a first plurality of downscaled reference samples and a first plurality of motion vector candidates each indicative of location of a corresponding one of the first plurality of downscaled reference samples; and
a main encoding pipeline configured to receive the source image data corresponding with the plurality of coding blocks and to determine encoding parameters to be used to encode the plurality of coding blocks based on motion vector candidates in the first plurality of motion vector candidates.

2. The video encoding system of claim 1, wherein the video encoding system is configured to generate the downscaled luma prediction block and the downscaled chroma prediction block due to the video encoding system operating in a first mode of operation.

3. The video encoding system of claim 2, wherein the first mode of operation corresponds to a motion compensated temporal filtering mode of operation.

4. The video encoding system of claim 2, wherein the video encoding system is configured to operate in the first mode of operation based on available processing bandwidth, available power, or both.

5. The video encoding system of claim 2, wherein, when operating in a second mode of operation different than the first mode of operation, the low resolution motion estimation block is configured to perform the one or more low resolution motion estimate searches based on the luma prediction block but not the chroma prediction block.

6. The video encoding system of claim 1, wherein the luma prediction block comprises different dimensions than the chroma prediction block.

7. The video encoding system of claim 1, wherein the low resolution pipeline comprises a scaler block configured to generate the downscaled image data from the source image data.

8. The video encoding system of claim 1, wherein the low resolution pipeline is communicatively coupled to image pre-processing circuitry separate from the low resolution pipeline and configured to generate the downscaled image data and full resolution image data from the source image data.

9. The video encoding system of claim 1, wherein:
the low resolution motion estimation block is configured to perform, based on at least a portion of the first plurality of motion vector candidates, a one or more additional low resolution motion estimation searches based on the luma prediction block and the chroma prediction block to determine a second plurality of motion vector candidates each indicative of location of a corresponding one of the first plurality of downscaled references samples; and
the main encoding pipeline is configured to determine the encoding parameters based on motion vector candidates in the second plurality of motion vector candidates.

10. The video encoding system of claim 1, wherein:
the plurality of coding blocks comprises a second chroma coding block;
the plurality of downscaled coding blocks comprises a second downscaled chroma prediction block corresponding with a second chroma prediction block in the second chroma coding block; and
the low resolution motion estimate block is configured to perform the one or more low resolution motion estimation searches based on the luma prediction block, the chroma prediction block, and the second chroma prediction block.

11. A non-transitory computer-readable medium comprising instructions that, when executed by image processing circuitry, cause the image processing circuitry to:
determine whether the image processing circuitry is to operate in a first mode of operation or a second mode of operation; and
cause the image processing circuitry to operate in the first mode of operation, wherein in the first mode of operation, the instructions, when executed, cause the image processing circuitry to:
receive, at a low resolution pipeline of the image processing circuitry, source image data corresponding with a plurality of coding blocks of a coding unit in an image, wherein the plurality of coding blocks comprises a luma coding block and a chroma coding block;
generate, by a low resolution motion estimation block of the low resolution pipeline, a plurality of downscaled coding blocks in downscaled image data generated from the source image data by downscaling resolution of the source image data corresponding with the plurality of coding blocks, wherein the plurality of downscaled coding blocks comprises:
a downscaled luma prediction block corresponding with a luma prediction block in the luma coding block; and
a downscaled chroma prediction block corresponding with a chroma prediction block in the chroma coding block;
perform, by the low resolution motion estimation block, one or more low resolution motion estimation searches based on the luma prediction block and the chroma prediction block to determine a first plurality of downscaled reference samples and a first plurality of motion vector candidates each indicative of location of a corresponding one of the first plurality of downscaled reference samples; and
determine, by a main encoding pipeline of the image processing circuitry, encoding parameters to be used to encode the plurality of coding blocks based on motion vector candidates in the first plurality of motion vector candidates.

12. The non-transitory computer-readable medium of claim 11, wherein, in the first mode of operation, the instructions, when executed, cause the image processing circuitry to perform motion compensated temporal filtering on motion vectors generated by the low resolution pipeline and the main encoding pipeline.

13. The non-transitory computer-readable medium of claim 11, wherein:
the luma coding block comprise a first set of dimensions; and
the chroma coding block comprises a second set of dimensions, a third set of dimensions, or a fourth set of dimensions, wherein the first set of dimensions, the second set of dimensions, the third set of dimensions, and the fourth set of dimensions are different from one another.

14. The non-transitory computer-readable medium of claim 11, wherein the instructions, when executed, cause the image processing circuitry to cause the image processing circuitry to operate in the second mode of operation, wherein in the second mode of operation, the instructions, when executed, cause the image processing circuitry to perform the one or more low resolution motion estimate searches based on the luma prediction block but not the chroma prediction block.

15. The non-transitory computer-readable medium of claim 14, wherein, in the second mode of operation, the plurality of downscaled coding blocks comprises the downscaled luma prediction block but not the downscaled chroma prediction block.

16. An electronic device, comprising:
a display; and
image processing circuitry communicatively coupled to the display, wherein the image processing circuitry comprises:
a low resolution pipeline configured to receive source image data corresponding with a plurality of coding blocks of a coding unit in an image, wherein the plurality of coding blocks comprises a luma coding block and a chroma coding block, wherein the low resolution pipeline comprises a low resolution motion estimation block programmed, in a first mode of operation, to:
generate a plurality of downscaled coding blocks in downscaled image data generated from the source image data by downscaling resolution of the source image data corresponding with the plurality of coding blocks, wherein the plurality of downscaled coding blocks comprises:
a downscaled luma prediction block corresponding with a luma prediction block in the luma coding block; and
a downscaled chroma prediction block corresponding with a chroma prediction block in the chroma coding block; and
perform one or more low resolution motion estimation searches based on the luma prediction block and the chroma prediction block to determine a first plurality of downscaled reference samples and a first plurality of motion vector candidates each indicative of location of a corresponding one of the first plurality of downscaled reference samples; and
a main encoding pipeline configured to receive the source image data corresponding with the plurality of coding blocks and to determine encoding parameters to be used to encode the plurality of coding blocks based on motion vector candidates in the first plurality of motion vector candidates.

17. The electronic device of claim 16, comprising an image sensor communicatively coupled to the image processing circuitry and configured to generate the source image data.

18. The electronic device of claim 16, comprising image pre-processing circuitry configured to generate the downscaled image data from the source image data.

19. The electronic device of claim 18 wherein:
the electronic device comprises memory separate from the image processing circuitry and configured to store the downscaled image data; and
the low resolution motion estimation block is configured to receive the downscaled image data from the memory.

20. The electronic device of claim 16, comprising a system-on-chip that comprises the image processing circuitry.
